(19) United States
(12) Patent Application Publication
(10) Pub. No.: US 2024/0056899 A1
(43) Pub. Date: Feb. 15, 2024

(54) TECHNIQUES FOR SIGNALING IN SUBBAND FULL-DUPLEX OPERATION

(71) Applicant: QUALCOMM Incorporated, San Diego, CA (US)

(72) Inventors: Qian Zhang, Basking Ridge, NJ (US); Yan Zhou, San Diego, CA (US); Muhammad Sayed Khairy Abdelghaffar, San Jose, CA (US); Tao Luo, San Diego, CA (US)

(21) Appl. No.: 17/886,421

(22) Filed: Aug. 11, 2022

(51) Int. Cl. H04W 28/26; H04W 72/04

(52) U.S. Cl. CPC H04W 28/26; H04W 72/0453

(57) ABSTRACT

Methods, systems, and devices for wireless communication are described. A user equipment (UE) may adjust signaling in a slot configured for subband full-duplex (SBFD) communications based on receiving scheduling information indicating a signal. In a first option, a corresponding subband may be extended to include the signal. If there are remaining frequency resources, the remaining reverse-direction subband may be used for corresponding communications. In a second option, the remaining frequency resources of the reverse-direction subband may be used for same-direction communications as the signal. In a third option, the signal may be canceled, or a portion of the signal that is outside the corresponding subband may be canceled. In a fourth option, the signal may be treated as an error. In some examples, the options may be configured based on a type of the signal, or based on a priority level of the signal.

### FIELD OF TECHNOLOGY

The following relates to wireless communication, including techniques for signaling in subband full-duplex operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for signaling in subband full-duplex (SBFD) operation. For example, the described techniques provide for enabling a user equipment (UE) to adjust signaling in a slot configured for SBFD communications based on receiving scheduling information indicating a configured signal in the slot. In a first option, a corresponding subband may be extended to include the configured signal. If there are remaining frequency resources, the remaining reverse-direction subband may still be used for corresponding communications. In a second option, the remaining frequency resources of the reverse-direction subband may be used for same-direction communications as the configured signal. In a third option, the configured signal may be canceled, or a portion of the configured signal that is outside the corresponding subband may be canceled. In a fourth option, the configured signal may be treated as an error. For example, if the signal is a downlink signal, the UE may skip receiving the configured signal and transmit feedback (e.g., a negative acknowledgment (NACK) feedback). In some examples, the options may be configured based on a type of the signal, or based on a priority level of the signal. A network entity may indicate priority-based rules to the UE for how to communicate the configured signal.

A method for wireless communication is described. The method may include obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, obtaining a second message indicating scheduling information for a signal, the scheduling information indicating a set of frequency resources of the slot, where the set of frequency resources includes a first frequency resource of the first subband and a second frequency resource of the second subband, and communicating using the set of frequency resources according to the first reservation, the second reservation, or both.

An apparatus for wireless communication is described. The apparatus may include at least one processor. The apparatus may also include memory including instructions executable by the at least one processor to cause the apparatus to obtain a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, obtain a second message indicating scheduling information for a signal, the scheduling information indicating a set of frequency resources of the slot, where the set of frequency resources includes a first frequency resource of the first subband and a second frequency resource of the second subband, and communicate using the set of frequency resources according to the first reservation, the second reservation, or both.

Another apparatus for wireless communication is described. The apparatus may include means for obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, means for obtaining a second message indicating scheduling information for a signal, the scheduling information indicating a set of frequency resources of the slot, where the set of frequency resources includes a first frequency resource of the first subband and a second frequency resource of the second subband, and means for communicating using the set of frequency resources according to the first reservation, the second reservation, or both.

A non-transitory computer-readable medium storing code for wireless communication is described. The code may include instructions executable by a processor to obtain a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, obtain a second message indicating scheduling information for a signal, the scheduling information indicating a set of frequency resources of the slot, where the set of frequency resources includes a first frequency resource of the first subband and a second frequency resource of the second subband, and communicate using the set of frequency resources according to the first reservation, the second reservation, or both.

In some examples of the method, apparatuses, and non-transitory computer-readable medium described herein, the communication may include operations, features, means, or instructions for monitoring the set of frequency resources for at least a first portion of the third message according to the first reservation, the second reservation, or both.

In some examples of the method, apparatuses, and non-transitory computer-readable medium described herein, the communication may include operations, features, means, or instructions for monitoring the second frequency resource of the second subband for the first portion of the third message according to the second reservation.

In some examples of the method, apparatuses, and non-transitory computer-readable medium described herein, the communication may include operations, features, means, or instructions for monitoring the third frequency resource for a second portion of the third message.

In some examples of the method, apparatuses, and non-transitory computer-readable medium described herein, the communication may include operations, features, means, or instructions for outputting, for transmission, at least a first portion of the third message using the set of frequency resources according to the first reservation, the second reservation, or both.

In some examples of the method, apparatuses, and non-transitory computer-readable medium described herein, the communication may include operations, features, means, or instructions for outputting, for transmission, the first portion of the third message using the first frequency resource of the first subband based on the first reservation.

In some examples of the method, apparatuses, and non-transitory computer-readable medium described herein, the communications may include operations, features, means, or instructions for outputting, for transmission, a second portion of the third message using a third one or more frequency resources of a guard band, the guard band including a third one or more subbands, where the set of frequency resources includes the guard band.

In some examples of the method, apparatuses, and non-transitory computer-readable medium described herein, the communication using the set of frequency resources may be independent of communicating the signal.

Some examples of the method, apparatuses, and non-transitory computer-readable medium described herein may further include operations, features, means, or instructions for outputting, for transmission, a feedback message independent of the communication, the feedback message including a negative acknowledgment associated with the signal.

In some examples of the method, apparatuses, and non-transitory computer-readable medium described herein, the communication using the set of frequency resources may be further in accordance with priority information associated with the signal.

Some examples of the method, apparatuses, and non-transitory computer-readable medium described herein may further include operations, features, means, or instructions for obtaining a third message indicating the priority information associated with the signal.

In some examples of the method, apparatuses, and non-transitory computer-readable medium described herein, the second direction may be different than the first direction.

A method for wireless communication is described. The method may include outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, outputting, for transmission, a second message indicating scheduling information for a signal, the scheduling information indicating a set of frequency resources of the slot, where the set of frequency resources includes a first frequency resource of the first subband and a second frequency resource of the second subband, and communicating using the set of frequency resources according to the first reservation, the second reservation, or both.

An apparatus for wireless communication is described. The apparatus may include at least one processor. The apparatus may also include memory including instructions executable by the at least one processor to cause the apparatus to output, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, output, for transmission, a second message indicating scheduling information for a signal, the scheduling information indicating a set of frequency resources of the slot, where the set of frequency resources includes a first frequency resource of the first subband and a second frequency resource of the second subband, and communicate using the set of frequency resources according to the first reservation, the second reservation, or both.

Another apparatus for wireless communication is described. The apparatus may include means for outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, means for outputting, for transmission, a second message indicating scheduling information for a signal, the scheduling information indicating a set of frequency resources of the slot, where the set of frequency resources includes a first frequency resource of the first subband and a second frequency resource of the second subband, and means for communicating using the set of frequency resources according to the first reservation, the second reservation, or both.

A non-transitory computer-readable medium storing code for wireless communication is described. The code may include instructions executable by a processor to output, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, output, for transmission, a second message indicating scheduling information for a signal, the scheduling information indicating a set of frequency resources of the slot, where the set of frequency resources includes a first frequency resource of the first subband and a second frequency resource of the second subband, and communicate using the set of frequency resources according to the first reservation, the second reservation, or both.

In some examples of the method, apparatuses, and non-transitory computer-readable medium described herein, the communication may include operations, features, means, or instructions for monitoring the set of frequency resources for at least a first portion of the third message according to the first reservation, the second reservation, or both.

In some examples of the method, apparatuses, and non-transitory computer-readable medium described herein, the communication may include operations, features, means, or instructions for monitoring the first frequency resource of the first subband for the first portion of the third message according to the first reservation.

In some examples of the method, apparatuses, and non-transitory computer-readable medium described herein, the communication may include operations, features, means, or instructions for monitoring the third frequency resource for a second portion of the third message.

Some examples of the method, apparatuses, and non-transitory computer-readable medium described herein may further include operations, features, means, or instructions for outputting, for transmission, a fourth message using a third frequency resource of the second subband according to the second reservation.

Some examples of the method, apparatuses, and non-transitory computer-readable medium described herein may further include operations, features, means, or instructions for monitoring a third frequency resource of the second subband for a fourth message.

In some examples of the method, apparatuses, and non-transitory computer-readable medium described herein, the communication may include operations, features, means, or instructions for outputting, for transmission, at least a first portion of the third message using the set of frequency resources according to the first reservation, the second reservation, or both.

In some examples of the method, apparatuses, and non-transitory computer-readable medium described herein, the communication may include operations, features, means, or instructions for outputting, for transmission, a first portion of the third message using the second frequency resource of the second subband according to the second reservation.

In some examples of the method, apparatuses, and non-transitory computer-readable medium described herein, the communication may include operations, features, means, or instructions for outputting, for transmission, a second portion of the third message using the third frequency resource.

Some examples of the method, apparatuses, and non-transitory computer-readable medium described herein may further include operations, features, means, or instructions for monitoring a third frequency resource of the first subband for a fourth message according to the first reservation, the fourth message associated with the first direction.

Some examples of the method, apparatuses, and non-transitory computer-readable medium described herein may further include operations, features, means, or instructions for outputting, for transmission, a fourth message using a third frequency resource of the first subband, the fourth message associated with the second direction.

In some examples of the method, apparatuses, and non-transitory computer-readable medium described herein, the communication using the set of frequency resources may be independent of communicating the signal.

Some examples of the method, apparatuses, and non-transitory computer-readable medium described herein may further include operations, features, means, or instructions for obtaining a feedback message including a negative acknowledgment associated with the signal.

In some examples of the method, apparatuses, and non-transitory computer-readable medium described herein, the communication using the set of frequency resources may be further in accordance with priority information associated with the signal.

Some examples of the method, apparatuses, and non-transitory computer-readable medium described herein may further include operations, features, means, or instructions for outputting, for transmission, a third message indicating the priority information associated with the signal.

In some examples of the method, apparatuses, and non-transitory computer-readable medium described herein, the second direction may be different than the first direction.

A UE is described. The UE may include one or more transceivers configured to receive a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction, receive a second message indicating scheduling information for a signal, the scheduling information indicating a set of frequency resources of the slot, wherein the set of frequency resources comprises a first frequency resource of the first subband and a second frequency resource of the second subband, and communicate using the set of frequency resources according to the first reservation, the second reservation, or both.

### BRIEF DESCRIPTION OF THE DRAWINGS

FIG. 1 illustrates an example of a wireless communications system that supports techniques for signaling in subband full-duplex (SBFD) operation in accordance with one or more aspects of the present disclosure.

FIG. 2 illustrates examples of multiplexing modes that support techniques for signaling in SBFD operation in accordance with one or more aspects of the present disclosure.

FIG. 3 illustrates an example of a signaling diagram that supports techniques for signaling in SBFD operation in accordance with one or more aspects of the present disclosure.

FIGS. 4 through 8 illustrate examples of communication schemes that supports techniques for signaling in SBFD operation in accordance with one or more aspects of the present disclosure.

FIG. 9 illustrates an example of a process flow that supports techniques for signaling in SBFD operation in accordance with one or more aspects of the present disclosure.

FIGS. 10 and 11 show block diagrams of devices that support techniques for signaling in SBFD operation in accordance with one or more aspects of the present disclosure.

FIG. 12 shows a block diagram of a communications manager that supports techniques for signaling in SBFD operation in accordance with one or more aspects of the present disclosure.

FIG. 13 shows a diagram of a system including a device that supports techniques for signaling in SBFD operation in accordance with one or more aspects of the present disclosure.

FIGS. 14 and 15 show block diagrams of devices that support techniques for signaling in SBFD operation in accordance with one or more aspects of the present disclosure.

FIG. 16 shows a block diagram of a communications manager that supports techniques for signaling in SBFD operation in accordance with one or more aspects of the present disclosure.

FIG. 17 shows a diagram of a system including a device that supports techniques for signaling in SBFD operation in accordance with one or more aspects of the present disclosure.

FIGS. 18 through 21 show flowcharts illustrating methods that support techniques for signaling in SBFD operation in accordance with one or more aspects of the present disclosure.

### DETAILED DESCRIPTION

In some cases, a network entity may implement a subband full-duplex (SBFD) communication scheme, where a first one or more subbands in a slot may be reserved for communications in a first direction (e.g., downlink) and a second one or more subbands in the slot may be reserved for communications in a second direction (e.g., uplink) different than the first direction. The effect of the SBFD scheme may be to increase a duty cycle for communications, which, for example, may reduce latency for uplink communications from a user equipment (UE). In some cases, however, a configured signal (e.g., a downlink signal or an uplink signal) may not be confined within the corresponding reserved subband.

According to the techniques described herein, a UE may adjust signaling in a slot configured for SBFD communications based on receiving scheduling information indicating a configured signal in the slot. In a first option, a corresponding subband may be extended to include the configured signal. If there are remaining frequency resources, the remaining reverse-direction subband may still be used for corresponding communications. In a second option, the remaining frequency resources of the reverse-direction subband may be used for same-direction communications as the configured signal. In a third option, the configured signal may be canceled, or a portion of the configured signal that is outside the corresponding subband may be canceled. In a fourth option, the configured signal may be treated as an error. For example, if the signal is a downlink signal, the UE may skip receiving the configured signal and transmit feedback (e.g., a negative acknowledgment (NACK) feedback). In some examples, the options may be configured based on a type of the signal, or based on a priority level of the signal. A network entity may indicate priority-based rules to the UE for how to communicate the configured signal.

Aspects of the disclosure are initially described in the context of wireless communications systems. Aspects of the disclosure are further illustrated by and described with reference to multiplexing modes, a signaling diagram, communication schemes, a process flow, apparatus diagrams, system diagrams, and flowcharts that relate to techniques for signaling in SBFD operation.

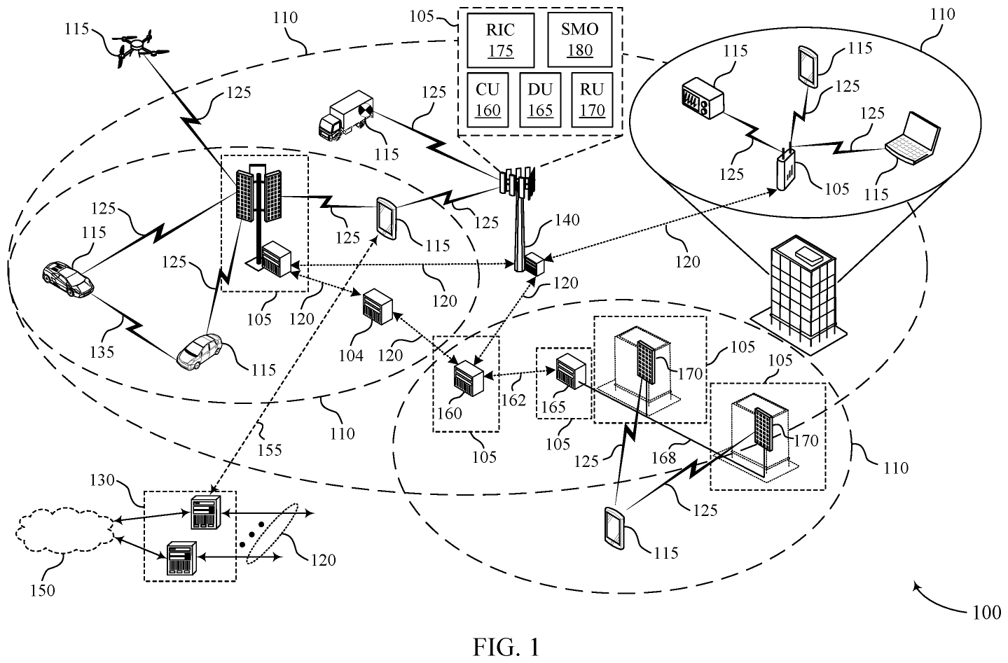

FIG. 1 illustrates an example of a wireless communications system 100 that supports techniques for signaling in SBFD operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for signaling in SBFD operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., a subband, which may include a set of subcarriers or resource blocks (RBs)) within a carrier, within a guard band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a UE 115 may adjust signaling in a slot configured for SBFD communications based on receiving scheduling information indicating a configured signal in the slot. In a first option, a corresponding subband may be extended to include the configured signal. If there are remaining frequency resources, the remaining reverse-direction subband may still be used for corresponding communications. In a second option, the remaining frequency resources of the reverse-direction subband may be used for same-direction communications as the configured signal. In a third option, the configured signal may be canceled, or a portion of the configured signal that is outside the corresponding subband may be canceled. In a fourth option, the configured signal may be treated as an error. For example, if the signal is a downlink signal, the UE 115 may skip receiving the configured signal and transmit feedback (e.g., a HARQ-NACK feedback message). In some examples, the options may be configured based on a type of the signal, or based on a priority level of the signal. A network entity 105 may indicate priority-based rules to the UE 115 for how to communicate the configured signal.

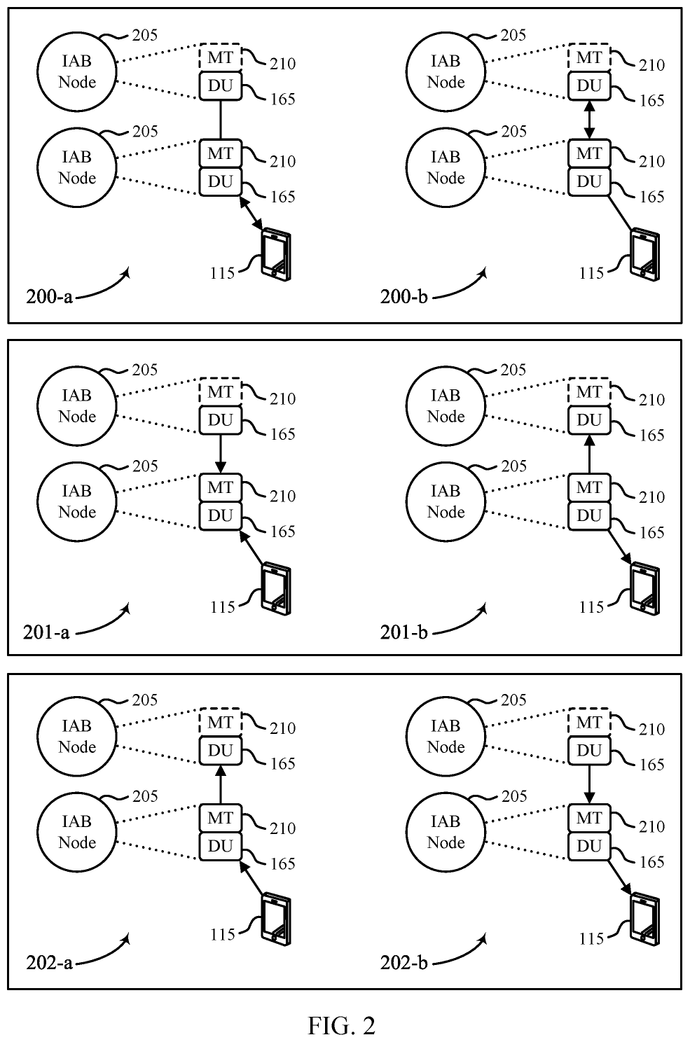

FIG. 2 illustrates an example of multiplexing modes 200, 201, and 202 that support techniques for signaling in SBFD operation in accordance with one or more aspects of the present disclosure. The multiplexing modes 200, 201, and 202 may be implemented to realize or facilitate aspects of the wireless communications system 100. For example, the multiplexing modes 200, 201, and 202 illustrate communication between IAB nodes 205, MT devices 210, DUs 165, and UEs 115, which may be examples of corresponding devices as illustrated by and described with reference to FIG. 1. In some implementations, the multiplexing modes 200, 201, and 202 may support one or more signaling-based mechanisms according to which a first device (such as an IAB node 205 or another network entity 105) may inform a UE 115 of which time and frequency resources may be used for full-duplex communication.

In some systems, a network entity 105 or one or more TRPs, or any combination thereof, may communicate with (e.g., transmit to, receive from, output for transmission to, obtain from, or any combination thereof) a UE 115 in accordance with a “baseline” non-full-duplex operation. In such systems, flexible TDD may be disabled at both the network entity 105 and the UE 115. Alternatively, a network entity 105 or one or more TRPs, or any combination thereof, may communicate with (e.g., transmit to, receive from, output for transmission to, obtain from, or any combination thereof) a UE 115 in accordance with any one or more of various types of full-duplex. Such types of full-duplex may involve full-duplex operation at the UE 115 or at the network entity 105 (optionally via one or more TRPs), or at both.

In a first example type of full-duplex, a UE 115 may communicate with a first TRP (such as a TRP 1) via downlink (such that the TRP 1 transmits signaling to the UE 115) and the UE 115 may communicate with a second TRP (such as a TRP 2) via uplink (such that the UE 115 transmits signaling to the TRP 2). In such a first example type of full-duplex (which may be associated with an mTRP deployment), flexible TDD may be disabled at a network entity 105 and flexible TDD may be enabled at the UE 115. In a second example type of full-duplex, a network entity 105 may communicate with a first UE 115 via downlink and may communicate with a second UE 115 via uplink. In such a second example type of full-duplex (which may be associated with an IAB deployment), flexible TDD may be enabled at the network entity 105 and flexible TDD may be disabled at the first and second UEs 115. In a third example type of full-duplex, a network entity 105 may communicate with a UE 115 via both downlink and uplink. In such a third example type of full-duplex, flexible TDD may be enabled at both the network entity 105 and the UE 115.

Further, one or more network entities 105 or one or more TRPs, or any combination thereof, may communicate with (e.g., transmit to, receive from, output for transmission to, obtain from, or any combination thereof) one or more UEs 115 in accordance with one or more of various deployment scenarios that leverage a type of full-duplex. In a first deployment scenario, a full-duplex network entity 105 (e.g., a base station 140 as illustrated by and described with reference to FIG. 1) may communicate with multiple half-duplex UEs 115. For example, a first network entity 105 may transmit downlink signaling to a first UE 115 and may concurrently receive uplink signaling from a second UE 115. A second network entity 105 may transmit downlink signaling to a third UE 115 and may concurrently receive uplink signaling from a fourth UE 115. In such deployment scenarios, cross-link interference (CLI) may occur between the various communicating devices (where uplink signaling may interference with downlink signaling) and each of the two full-duplex network entities 105 may experience some amount of self-interference.

In a second deployment scenario, a full-duplex network entity 105 may communicate with a full-duplex UE 115 (such as a full-duplex customer premises equipment (CPE)). For example, the full-duplex network entity 105 may transmit downlink signaling to the full-duplex UE 115 and concurrently receive uplink signaling from the full-duplex UE 115. In some aspects, the full-duplex network entity 105 also may transmit downlink signaling to another UE 115 (such as a half-duplex UE 115) and, in such aspects, CLI may occur between the two UEs 115. Further, the full-duplex network entity 105 may experience CLI from another network entity 105 and both of the full-duplex network entity 105 and the full-duplex UE 115 may experience self-interference.

In a third deployment scenario, a half-duplex network entity 105 or TRP (such as in an mTRP deployment) may communicate with a full-duplex UE 115 (such as a full-duplex CPE). For example, a first network entity 105 or TRP may transmit downlink signaling to the full-duplex UE 115 and the full-duplex UE 115 may concurrently transmit uplink signaling to a second network entity 105 or TRP. In some aspects, the first network entity 105 or TRP also may transmit downlink signaling to another UE 115 (such as a half-duplex UE 115) and, in such aspects, CLI may occur between the two UEs 115. Further, the two network entities 105 or TRPs may experience CLI and the full-duplex UE 115 may experience self-interference.

In a fourth deployment scenario, a full-duplex IAB node may communicate with various UEs 115 (such as half-duplex UEs 115). For example, an IAB node 205 (such as an IAB donor) may control or operate multiple IAB nodes 104 and one or more of the multiple IAB nodes 104 may support full-duplex operation. For example, the IAB node 205 may control or operate a first IAB node 104 that is capable of transmitting downlink signaling to a first UE 115 and concurrently receiving uplink signaling from a second UE 115 and may control or operate a second IAB node 104 that is capable of transmitting downlink signaling to a third UE 115 and concurrently receiving uplink signaling from a fourth UE 115. In such deployments, the first and second IAB nodes 104 may experience CLI from each other or self-interference, or both. In some aspects, the IAB nodes 104 may support a conditional duplexing capability. Additionally, or alternatively, the IAB nodes 104 may support single frequency full-duplex and FDM or spatial division multiplexing (SDM) with a resource block group (RBG) granularity.

In some aspects, a network entity 105, one or more TRPs, and a UE 115 may support various evaluation techniques and performance evaluation metrics associated with different deployment scenarios for full-duplex operation (such as for NR duplexing). Further, a network entity 105, one or more TRPs, and a UE 115 may support one or more techniques to support co-existence with other systems in any co-channels or adjacent channels for subband non-overlapping full-duplex operation or for dynamic or flexible TDD, or for both. For example, a network entity 105, one or more TRPs, and a UE 115 may support techniques associated with duplex operation evolution for NR TDD across various spectrums, including in an unpaired spectrum. In such examples, the network entity 105 (via the one or more TRPs) may support full-duplex operation, a UE 115 may support half-duplex operation, and the network entity 105 and the UE 115 may configure or expect no restrictions on which frequency ranges are available for use.

Such techniques may include various full-duplex types or schemes and corresponding metrics to evaluate a performance of such full-duplex types or schemes, inter-network entity 105 and inter-UE 115 CLI mitigation techniques, intra-subband CLI and inter-subband CLI mitigation techniques (such as in the implementation of subband non-overlapping full-duplex), or a metric-based evaluation procedure for an impact of full-duplex operation on half-duplex operation (assuming co-existence in co-channel and adjacent channels). Additionally, or alternatively, such techniques may include a metric-based evaluation procedure for an impact on RF constraints considering adjacent channel co-existence or for an impact on RF constraints considering self-interference, inter-subband CLI and inter-operator CLI at network entities 105, and inter-subband CLI and inter-operator CLI at UEs 115. Further, such techniques may include antenna or RF and algorithm design for interference mitigation, including antenna isolation, transmission interference management suppression in a receive-side part, filtering, and digital interference suppression. Further, such techniques may comply with one or more regulatory or network specifications associated with full-duplex operation in TDD unpaired spectrums.

In some aspects, various devices within a system may support a signaling mechanism to inform a UE 115 of the time or frequency location of subbands that a network entity 105 may use for full-duplex operation, such as for SBFD operation. Further, various devices may support a specific resource allocation in symbols or slots with subbands that a network entity 105 may use for full-duplex operation, such as SBFD operation.

The multiplexing modes 200, 201, and 202 may support various types of resource management and various types of multiplexing. For example, a multiplexing mode 200-a and a multiplexing mode 200-b may illustrate TDM. The multiplexing mode 200-a may illustrate DU transmission and reception and the multiplexing mode 200-b may illustrate MT transmission and reception. In the examples of the multiplexing mode 200-a and the multiplexing mode 200-b, MT downlink or uplink may use a first set of time domain resources and DU downlink or uplink may use a second set of (non-overlapping) time domain resources.

The multiplexing mode 201-a and the multiplexing mode 201-b may illustrate SDM reception and SDM transmission, respectively. For example, the multiplexing mode 201-a illustrates MT reception and DU reception (which may occur using overlapping or non-overlapping time or frequency resources) and the multiplexing mode 201-b illustrates MT transmission and DU transmission (which may occur using overlapping or non-overlapping time or frequency resources). The multiplexing mode 202-a and the multiplexing mode 202-b illustrate example full-duplex scenarios. For example, the multiplexing mode 202-a illustrates MT transmission and DU reception (which may occur using overlapping or non-overlapping time or frequency resources) and the multiplexing mode 202-b illustrates MT reception and DU transmission (which may occur using overlapping or non-overlapping time or frequency resources).

In any SDM or full-duplex scenarios, communication may occur concurrently or at different times and may occur using different frequency resources, using partially overlapping frequency resources, or using the same frequency resources. For example, various devices or components may communicate MT downlink or uplink and DU downlink or uplink using non-overlapping frequency resources (e.g., in an FDM scheme), using partially overlapping frequency resources, or using fully overlapping frequency resources. Further, various devices or components may use any combination of MT downlink or uplink and DU downlink or uplink across different subbands (e.g., across different subbands). Further, various devices or components may support switching across different configurations over time (e.g., slot by slot).

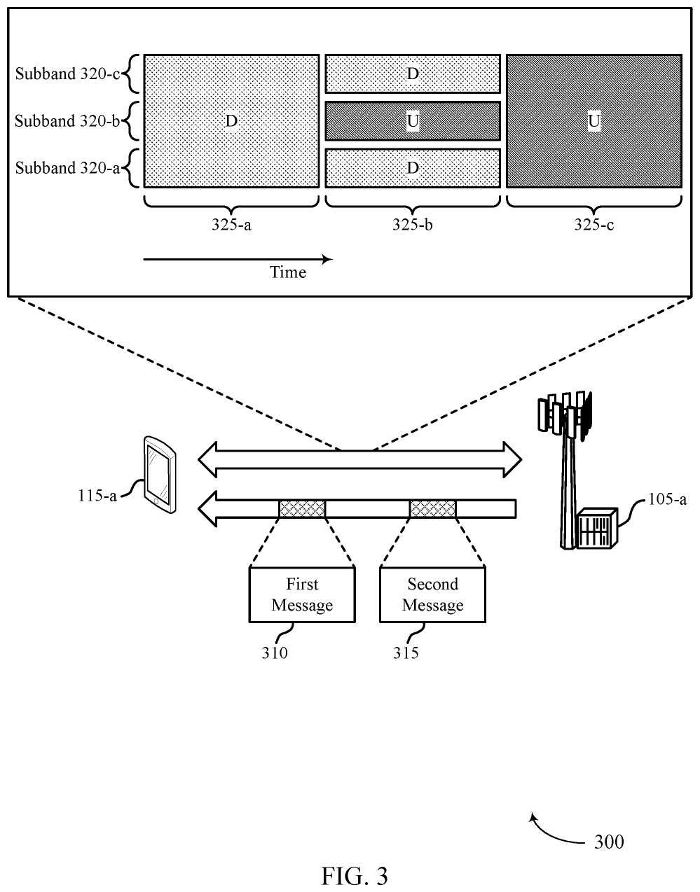

FIG. 3 illustrates an example of a signaling diagram 300 that supports techniques for signaling in SBFD operation in accordance with one or more aspects of the present disclosure. The signaling diagram 300 may implement or be implemented to realize or facilitate aspects of the wireless communications system 100 or any one or more of the multiplexing modes 200, 201, and 202. For example, the signaling diagram 300 illustrates communication between a UE 115-a and a network entity 105-a, which may be examples of corresponding devices described with reference to FIG. 1. In some implementations, the UE 115-a and the network entity 105-a may support one or more signaling-based mechanisms according to which the network entity 105-a may inform the UE 115-a of which time and frequency resources may be used for full-duplex communication via per subband slot format configurations.

In some cases, the UE 115-a and the network entity 105-a may leverage subband-specific slot format configurations to indicate which time or frequency resources are scheduled for full-duplex communication and select between a subband-specific slot format or a baseline slot format in a same manner. Such signaling mechanisms may facilitate greater adoption of full-duplex communication and simplify a scheduling of full-duplex communication.

In some cases, full-duplex communication may result in or otherwise cause self-interference at one or both of the UE 115-a and the network entity 105-a. Accordingly, in some implementations, the UE 115-a and the network entity 105-a may further support one or more configuration- or signaling-based mechanisms according to which the UE 115-a and the network entity 105-a may configure a guard band between frequency resources that are allocated for concurrent uplink and downlink communication in line with subband-specific slot format configurations. In other words, the UE 115-a and the network entity 105-a may support communication schemes according to which the UE 115-a and the network entity 105-a may select or indicate guard band RBs during symbols or slots associated with full-duplex communication.

As illustrated in FIG. 3, the UE 115-a and the network entity 105-a may be configured to communicate in one or more time intervals 325 (e.g., one or more slots). For example, a time interval 325-a may be configured for communications in a first direction (e.g., downlink communications) and a time interval 325-c may be configured for communications in a second direction (e.g., uplink communications). In some examples, the network entity 105-a may output a first message 310 configuring a time interval 325-b for SBFD communications. For example, the first message 310 may indicate that one or more subbands 320 (e.g., a subband 320-a and a subband 320-c) are reserved for communications in the first direction (e.g., downlink communications) and one or more subbands 320 (e.g., a subband 320-b) are reserved for communications in the second direction (e.g., uplink communications) in the time interval 325-b.

In some cases, however, a configured signal (e.g., a downlink signal or an uplink signal) may not be confined within a reserved subband 320. For example, the network entity 105-a may output a second message 315 that indicates scheduling information for the configured signal in the time interval 325-b. In some examples, the configured signal may include a synchronization signal block (SSB), a CORESET (e.g., CORESETO), a semi-persistent signaling (SPS) transmission, a configured grant (CG) transmission, a physical uplink control channel (PUCCH), a channel state information reference signal (CSI-RS), a radio link monitoring (RLM) signal, a beam failure detection (BFD) signal, a physical random access channel (PRACH), another reference signal, another control signal, or another data signal.

As described herein, the UE 115-a may adjust signaling in the time interval 325-b based on the scheduling information in the second message 315. In a first option, a corresponding subband 320 may be extended to include the configured signal for a portion of the time interval 325-b. If there are remaining frequency resources, the remaining reverse-direction subband 320 may still be used for corresponding communications. In a second option, the remaining frequency resources of the reverse-direction subband 320 may be used for same-direction communications as the configured signal. In a third option, the configured signal may be canceled, or a portion of the configured signal that is outside the corresponding subband 320 may be canceled. In a fourth option, the configured signal may be treated as an error. For example, if the signal is a downlink signal, the UE 115-a may skip receiving the configured signal and transmit feedback (e.g., NACK feedback) in a subsequent time interval 325. In some examples, the options may be configured based on a type of the signal, or based on a priority level of the signal. The network entity 105-a may indicate priority-based rules to the UE 115-a for how to communicate the configured signal.

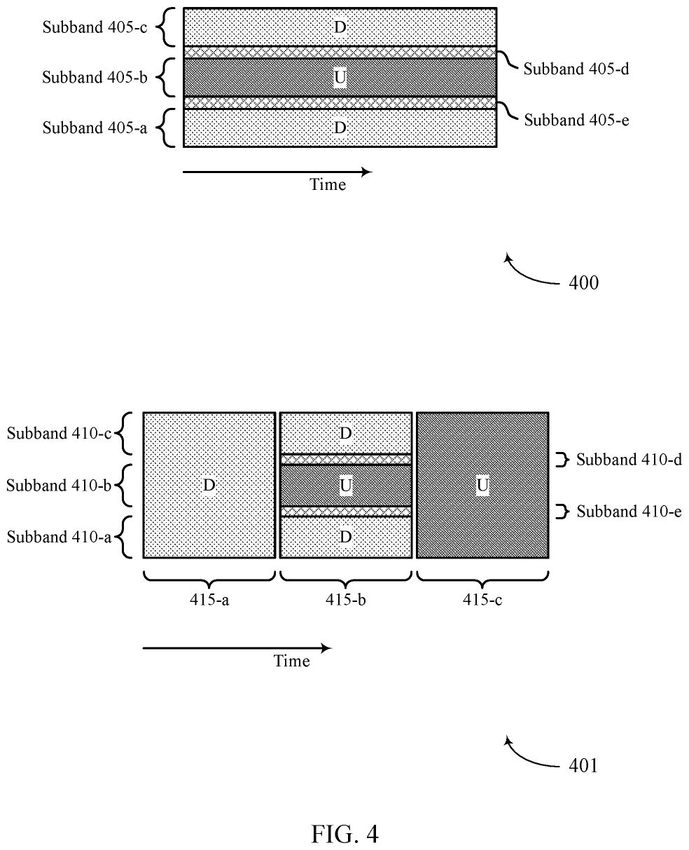

FIG. 4 illustrates examples of communication schemes 400 that support techniques for signaling in SBFD operation in accordance with one or more aspects of the present disclosure. The communication schemes 400 and 401 may implement or be implanted to realize aspects of the wireless communications system 100, any one or more of the multiplexing modes 200, 201, and 202, or the signaling diagram 300. For example, a UE 115 and a network entity 105 may employ the communication schemes 400 and 401 to add a guard band between frequency resources that are allocated for concurrent uplink and downlink communication in line with subband-specific slot format configurations.

In accordance with the communication schemes 400 and 401, the UE 115 and the network entity may define one or more relatively narrower subbands that represent guard band RBs between each downlink and uplink subband. A slot format associated with such a narrow guard band may include “NA” values or a bitmap (where a first bit, such as a 0 bit, indicates that a corresponding slot or symbol is available for use and a second bit, such as a 1 bit, indicates that a corresponding sot or symbol is unavailable for use).

For example, and as illustrated by the communication scheme 400, the UE 115 and the network entity 105 may support subband-specific slot format configurations for multiple subbands 405, including a subband 405-a, a subband 405-b, a subband 405-c, a subband 405-d, and a subband 405-e. The network entity 105 may indicate a first slot format configuration of “DDDDD” for a first index corresponding to the subband 405-a, a second slot format configuration of “UUUUU” for a second index corresponding to the subband 405-b, and a third slot format configuration of “DDDDD” for a third index corresponding to the subband 405-c. To indicate guard bands between the subband 405-a, the subband 405-b, and the subband 405-c, the network entity 105 may indicate a slot format of “NA . . . NA” or “11111” for a fourth index corresponding to the subband 405-d and another slot format of “NA . . . NA” or “11111” for a fifth index corresponding to the subband 405-e. Such slot formats of “NA . . . NA” or “11111” may indicate that the RBs of the subband 405-d and the subband 405-e are unavailable for communications and function as a guard band for full-duplex communication.

For further example, and as illustrated by the communication scheme 401, the UE 115 and the network entity 105 may support subband-specific slot format configurations for multiple subbands 410, including a subband 410-a, a subband 410-b, a subband 410-c, a subband 410-d, and a subband 410-e. The network entity may indicate a first slot format of “DDDDDDDDDDUUUUU” for a first index corresponding to the subband 410-a, a second slot format of “DDDDDUUUUUUUUUU” for a second index corresponding to the subband 410-b, and a third slot format of “DDDDDDDDDDUUUUU” for a third index corresponding to the subband 410-c. As such, each of the subband 410-a, the subband 410-b and the subband 410-c may be allocated for downlink communication during a first time interval 415-a (which may include 5 symbols or slots). During a second time interval 415-b (which may include 5 symbols or slots), the subband 410-a and the subband 410-c may be allocated for downlink communication and the subband 410-b may be allocated for uplink communication. During the third time interval 415-c (which may include 5 symbols or slots), each of the subband 410-a, the subband 410-b and the subband 410-c may be allocated for uplink communication.

The network entity 105 may further indicate (e.g., via the second message) a slot format of “DDDDDNA . . . NAUUUUU” or “000001111100000” for a fourth index corresponding to the subband 410-d and another slot format of “DDDDDNA . . . NAUUUUU” or “000001111100000” for a fifth index corresponding to the subband 410-e. Such slot formats of “NA . . . NA” or “11111” may indicate that the RBs of the subband 410-d and the subband 410-e are unavailable for communications and function as a guard band for full-duplex communication. As such, the UE 115 and the network entity 105 may use the subband 410-d and the subband 410-e as guard bands during the second time interval 415-b, but may otherwise use the subband 410-d and the subband 410-e for communication (such as during the first time interval 415-a and the third time interval 415-c).

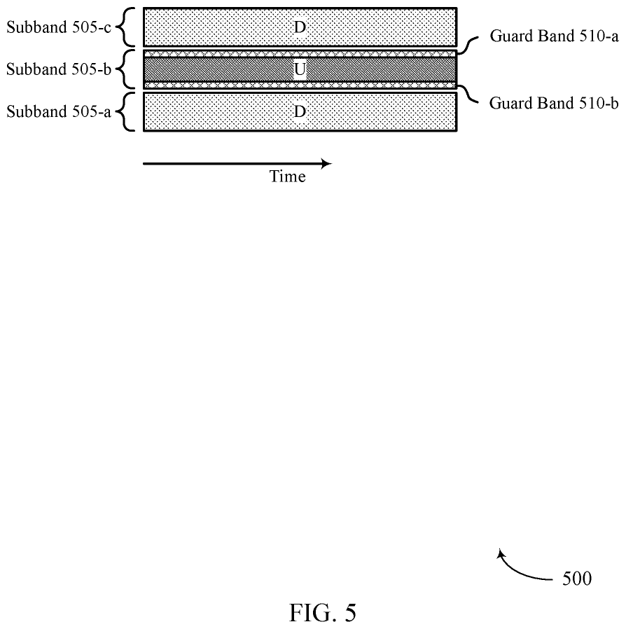

FIG. 5 illustrates an example of a communication scheme 500 that supports techniques for signaling in SBFD operation in accordance with one or more aspects of the present disclosure. The communication scheme 500 may implement or be implanted to realize aspects of the wireless communications system 100, any one or more of the multiplexing modes 200, 201, and 202, or the signaling diagram 300. For example, a UE 115 and a network entity 105 may employ the communication scheme 500 to add a guard band 510 between frequency resources, such as subbands 505, that are allocated for concurrent uplink and downlink communication in line with subband-specific slot format configurations.

In some implementations, the network entity 105 may explicitly signal one or more guard bands 510 to use between subbands 505 associated with different transmission directions. For example, the network entity 105 may indicate a value N, which may be a configurable value, and a quantity of N RBs may accordingly be left unused when applicable (e.g., when adjacent subbands 505 are allocated for uplink and downlink, respectively, during an at least partially overlapping time interval). For example, a CU entity may indicate N to a DU entity, and the DU entity may leave N RBs as a guard band 510 when applicable.

Additionally, or alternatively, the UE 115 and the network entity 105 may support a rule (such as a rule provided by a network specification) to indicate that the UE 115 and the network entity 105 are to borrow N RBs in between each downlink and uplink subband 505 from either or both of a downlink subband 505 or an uplink subband 505 as guard bands 510 on the associated SBFD symbols or slots. N may be indicated from the network entity 105 (and configurable), may be a fixed value, or may be a function of, for example, a size of the subband 505 from which the RBs are reserved.

For example, and as illustrated by the communication scheme 500, a subband 505-a may be configured for downlink communication, a subband 505-b may be configured for uplink communication, and a subband 505-c may be configured for downlink communication. As such, in some examples, the UE 115 and the network entity 105 may reserve RBs from the subband 505-b and refrain from using the reserved RBs for communication. For example, the UE 115 and the network entity 105 may use a first set of reserved RBs as a guard band 510-a between the subband 505-b and the subband 505-c and may use a second set of reserved RBs as a guard band 510-b between the subband 505-a and the subband 505-b. Further, although illustrated and described in the context of reserving RBs from the subband 505-b, the UE 115 and the network entity 105 may additionally, or alternatively, reserve RBs from one or both of the subband 505-a and the subband 505-c.

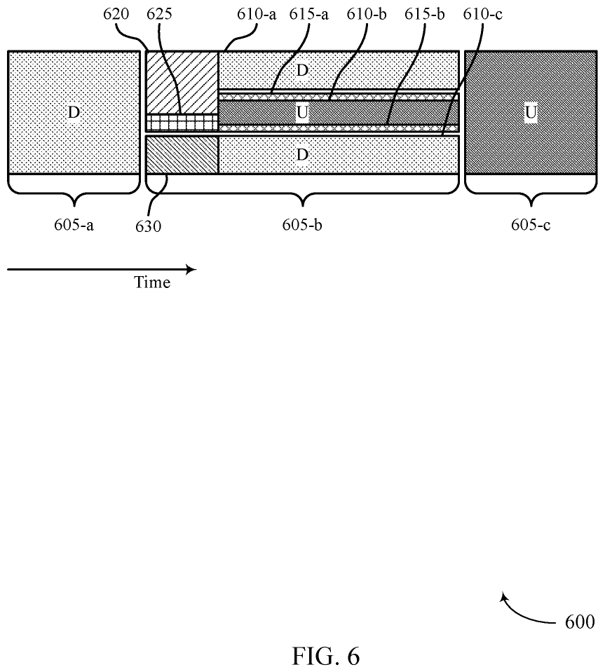

FIG. 6 illustrates an example of a communication scheme 600 that supports techniques for signaling in SBFD operation in accordance with one or more aspects of the present disclosure. The communication scheme 600 may implement or be implanted to realize aspects of the wireless communications system 100, any one or more of the multiplexing modes 200, 201, and 202, or the signaling diagram 300. For example, a UE 115 and a network entity 105 may employ the communication scheme 600 to improve SBFD communications.

As illustrated in FIG. 6, the UE 115 and the network entity 105 may be configured to communicate in one or more time intervals 605 (e.g., one or more slots). For example, a time interval 605-a may be configured for communications in a first direction (e.g., downlink communications) and a time interval 605-c may be configured for communications in a second direction (e.g., uplink communications). In some examples, the network entity 105 may output a first message configuring a time interval 605-b for SBFD communications. For example, the first message may indicate that one or more subbands 610 (e.g., a subband 610-a and a subband 610-c) are reserved for communications in the first direction (e.g., downlink communications) and one or more subbands 610 (e.g., a subband 610-b) are reserved for communications in the second direction (e.g., uplink communications) in the time interval 605-b. In some examples, the first message may further indicate one or more guard bands 615 between subbands 610. For example, a guard band 615-a may separate the subband 610-a and the subband 610-b, and a guard band 615-b may separate the subband 610-b and the subband 610-c.

In some cases, however, a configured signal 620 (e.g., a downlink signal or an uplink signal) may not be confined within a reserved subband 610. For example, the network entity 105 may output a second message that indicates scheduling information for the configured signal 620 in the time interval 605-b. As described herein, the UE 115 may adjust signaling in the time interval 605-b based on the scheduling information in the second message.

In some examples, a subband 610 (e.g., the subband 610-a) may be extended to include frequency resources of the configured signal 620 for a portion of the time interval 605-b. That is, as illustrated in FIG. 6, the subband 610-a may be extended to include frequency resources of the subband 610-b and, in some cases, frequency resources of the guard band 615-a. Based on extending the subband 610-a, the UE may be configured to communicate (e.g., transmit, receive, obtain, or output for transmission) the configured signal 620 in the extended subband 610-a.

In some examples, if there are remaining frequency resources in a portion 625 of the subband 610-b, the portion 625 may still be used for corresponding communications in the configured direction of the subband 610-b. In some examples, the portion 625 of the subband 610-b may be used for same-direction communications as the configured signal 620. In some examples, the UE 115 may adjust signaling in a set of RBs 630 in the subband 610-c, where the set of RBs 630 may overlap with the configured signal 620 in the time domain. For example, the UE 115 and the network entity 105 may be configured to use the set of RBs 630 for same-direction communications as the configured signal 620, or the UE 115 and the network entity 105 may be configured to use the set of RBs 630 for corresponding communications in the configured direction of the subband 610-c. In some examples, the operations for communicating the configured signal 620 may be based on a type of the configured signal 620, or based on a priority level of the configured signal 620. The network entity 105 may indicate priority-based rules to the UE 115 for how to communicate the configured signal 620.

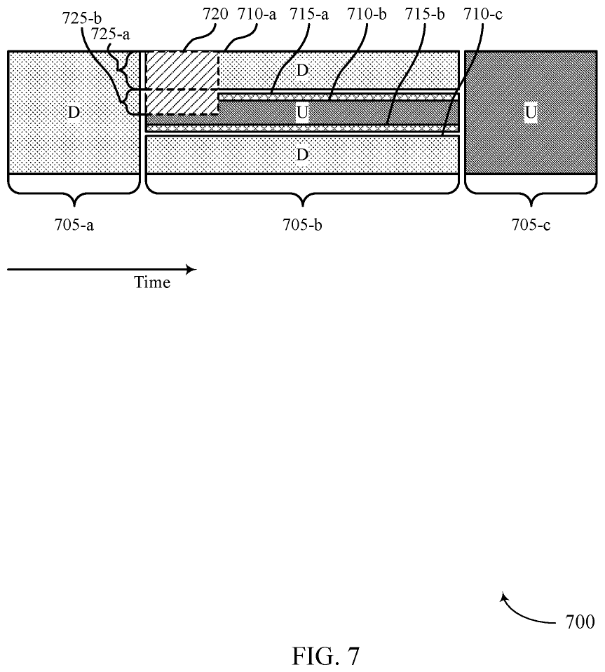

FIG. 7 illustrates an example of a communication scheme 700 that supports techniques for signaling in SBFD operation in accordance with one or more aspects of the present disclosure. The communication scheme 700 may implement or be implanted to realize aspects of the wireless communications system 100, any one or more of the multiplexing modes 200, 201, and 202, or the signaling diagram 300. For example, a UE 115 and a network entity 105 may employ the communication scheme 700 to improve SBFD communications.

As illustrated in FIG. 7, the UE 115 and the network entity 105 may be configured to communicate in one or more time intervals 705 (e.g., one or more slots). For example, a time interval 705-a may be configured for communications in a first direction (e.g., downlink communications) and a time interval 705-c may be configured for communications in a second direction (e.g., uplink communications). In some examples, the network entity 105 may output a first message configuring a time interval 705-b for SBFD communications. For example, the first message may indicate that one or more subbands 710 (e.g., a subband 710-a and a subband 710-c) are reserved for communications in the first direction (e.g., downlink communications) and one or more subbands 710 (e.g., a subband 710-b) are reserved for communications in the second direction (e.g., uplink communications) in the time interval 705-b. In some examples, the first message may further indicate one or more guard bands 715 between subbands 710. For example, a guard band 715-a may separate the subband 710-a and the subband 710-b, and a guard band 715-b may separate the subband 710-b and the subband 710-c.

In some cases, however, a configured signal 720 (e.g., a downlink signal or an uplink signal) may not be confined within a reserved subband 710. For example, the network entity 105 may output a second message that indicates scheduling information for the configured signal 720 in the time interval 705-b. As described herein, the UE 115 may adjust signaling in the time interval 705-b based on the scheduling information in the second message.

In some examples, the configured signal 720 may be canceled. That is, the network entity 105 and the UE 115 may be configured to refrain from communicating the configured signal 720. In some examples, the network entity 105 may transmit scheduling information that indicates a subsequent time interval 705 in which the configured signal 720 is to be communicated. In some examples, the network entity 105 and the UE 115 may be configured to communicate a portion 725-a of the configured signal 720 that is within the reserved subband 710-a, and cancel a portion 725-b of the configured signal that is outside the subband 710-a. In some examples, the operations for communicating the configured signal 720 may be based on a type of the configured signal 720, or based on a priority level of the configured signal 720. The network entity 105 may indicate priority-based rules to the UE 115 for how to communicate the configured signal 720.

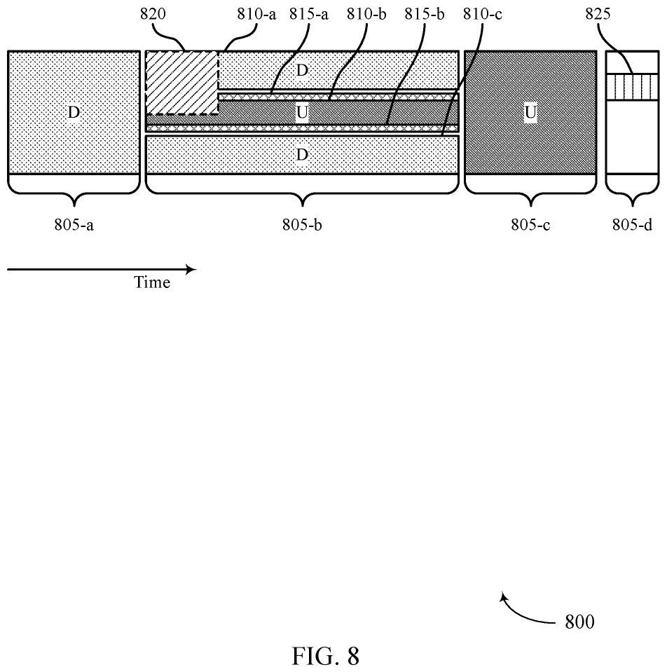

FIG. 8 illustrates an example of a communication scheme 800 that supports techniques for signaling in SBFD operation in accordance with one or more aspects of the present disclosure. The communication scheme 800 may implement or be implanted to realize aspects of the wireless communications system 100, any one or more of the multiplexing modes 200, 201, and 202, or the signaling diagram 300. For example, a UE 115 and a network entity 105 may employ the communication scheme 800 to improve SBFD communications.

As illustrated in FIG. 8, the UE 115 and the network entity 105 may be configured to communicate in one or more time intervals 805 (e.g., one or more slots). For example, a time interval 805-a may be configured for communications in a first direction (e.g., downlink communications) and a time interval 805-c may be configured for communications in a second direction (e.g., uplink communications). In some examples, the network entity 105 may output a first message configuring a time interval 805-b for SBFD communications. For example, the first message may indicate that one or more subbands 810 (e.g., a subband 810-a and a subband 810-c) are reserved for communications in the first direction (e.g., downlink communications) and one or more subbands 810 (e.g., a subband 810-b) are reserved for communications in the second direction (e.g., uplink communications) in the time interval 805-b. In some examples, the first message may further indicate one or more guard bands 815 between subbands 810. For example, a guard band 815-a may separate the subband 810-a and the subband 810-b, and a guard band 815-b may separate the subband 810-b and the subband 810-c.

In some cases, however, a configured signal 820 (e.g., a downlink signal or an uplink signal) may not be confined within a reserved subband 810. For example, the network entity 105 may output a second message that indicates scheduling information for the configured signal 820 in the time interval 805-b. As described herein, the UE 115 may adjust signaling in the time interval 805-b based on the scheduling information in the second message.

In some examples, the configured signal 820 may be treated as an error. For example, if the configured signal 820 is a downlink signal, the UE 115 may skip monitoring for the configured signal 820 and transmit a feedback message 825 (e.g., NACK feedback) in a time interval 805-d. In some examples, the operations for communicating the configured signal 820 may be based on a type of the configured signal 820, or based on a priority level of the configured signal 820. The network entity 105 may indicate priority-based rules to the UE 115 for how to communicate the configured signal 820.

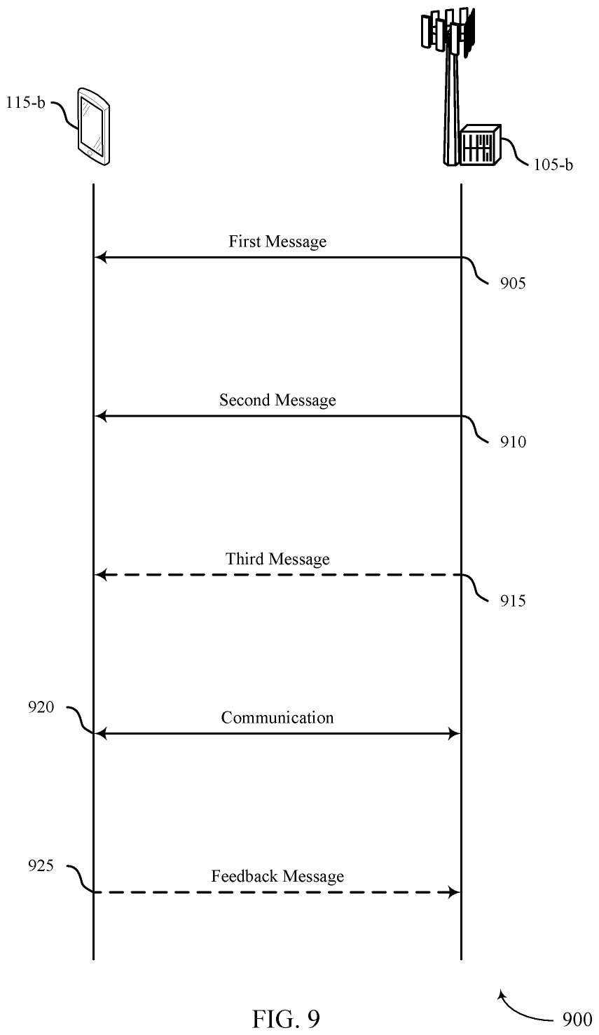

FIG. 9 illustrates an example of a process flow 900 that supports techniques for signaling in SBFD operation in accordance with one or more aspects of the present disclosure. The process flow 900 may implement or be implanted to realize aspects of the wireless communications system 100, any one or more of the multiplexing modes 200, 201, and 202, or the signaling diagram 300. For example, the process flow 900 may include example operations associated with a UE 115-b or a network entity 105-b, which may be examples of corresponding devices described with reference to FIG. 1. In the following description of the process flow 900, the operations between the UE 115-b and the network entity 105-b may be performed in a different order than the example order shown, or the operations performed by the UE 115-b or the network entity 105-b may be performed in different orders or at different times. Some operations may also be omitted from the process flow 900, and other operations may be added to the process flow 900. The operations performed by the UE 115-b and the network entity 105-b may support improvements to SBFD operations and, in some examples, may increase communications efficiency, among other benefits.

At 905, the network entity 105-b may output a first message configuring a time interval (e.g., a slot) for SBFD communications. For example, the first message may indicate that one or more subbands are reserved for communications in a first direction (e.g., uplink communications) and one or more subbands are reserved for communications in a second direction (e.g., downlink communications) in the time interval. In some examples, the first message may further indicate one or more guard bands between the reserved subbands.

At 910, the network entity 105-b may output a second message that indicates scheduling information for a signal in the time interval. That is, the second message may indicate a set of frequency resources for communicating the signal. The signal may be an uplink signal, a downlink signal, or a signal in another direction. The signal, as indicated in the scheduling information, may not be confined within a reserved subband. In some examples, the signal may include an SSB, a CORESET (e.g., CORESETO), an SPS transmission, a CG transmission, a PUCCH, a CSI-RS, an RLM signal, a BFD signal, a PRACH, another reference signal, another control signal, or another data signal.

In some examples, at 915, the network entity 105-b may output a third message that indicates priority information associated with the signal. In some examples, the third message may be included with the second message in a single transmission.

At 920, the UE 115-b and the network entity 105-b may communicate in the set of frequency resources. In some examples, the UE 115-b may adjust signaling in the set of frequency resources based on the scheduling information in the second message. In a first option, a corresponding subband may be extended to include the signal for a portion of the time interval. If there are remaining frequency resources, the remaining reverse-direction subband may still be used for corresponding communications. In a second option, the remaining frequency resources of the reverse-direction subband may be used for same-direction communications as the signal. In a third option, the signal may be canceled, or a portion of the signal that is outside the corresponding subband may be canceled. In a fourth option, the signal may be treated as an error.

In some examples, the options may be configured based on a type of the signal, or based on a priority level of the signal (e.g., based on the priority information included in the third message). In a first example, the signal (e.g., an SSB, a PRACH, or a CORESETO) may be assigned a first priority level (e.g., a “high” priority), and the UE 115-b and the network entity 105-b may apply the first option or the second option for the communication. In a second example, the signal (e.g., an SPS transmission, a CG transmission, a reference signal, or a PUCCH carrying a channel state information (CSI) report or a scheduling request (SR)) may be assigned a second priority level (e.g., a “middle” priority), and the UE 115-b and the network entity 105-b may apply the first option, the second option, or the third option for the communication. In a third example, the signal (e.g., an SPS transmission that does not include urgent traffic) may be assigned a third priority level (e.g., a “low” priority), and the UE 115-b and the network entity 105-b may apply the third option or the fourth option for the communication.

In some examples, at 925, the UE 115-b may output a feedback message associated with the signal. For example, if the signal is a downlink signal and the UE applies the fourth option, the UE 115-b may skip receiving the signal in the communication at 920 and transmit NACK feedback in the feedback message. By implementing one or more of the described techniques for SBFD communications, the UE 115-b and the network entity 105-b may be able to transmit data more efficiently, or in a manner that increases data throughput, or considers power consumption or processing load, among other considerations.

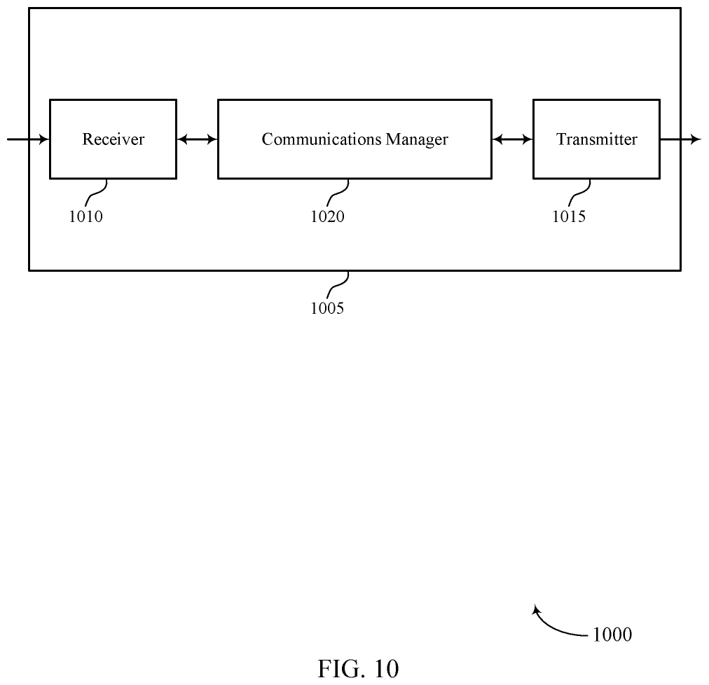

FIG. 10 shows a block diagram 1000 of a device 1005 that supports techniques for signaling in SBFD operation in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for signaling in SBFD operation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for signaling in SBFD operation). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for signaling in SBFD operation as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 may be configured as or otherwise support a means for obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The communications manager 1020 may be configured as or otherwise support a means for obtaining a second message indicating scheduling information for a signal, the scheduling information indicating a set of frequency resources of the slot, where the set of frequency resources includes a first frequency resource of the first subband and a second frequency resource of the second subband. The communications manager 1020 may be configured as or otherwise support a means for communicating using the set of frequency resources according to the first reservation, the second reservation, or both.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, or more efficient utilization of communication resources, among other benefits.

Means for receiving or means for obtaining may include a receiver (such as the receiver 1010 or a receive processor) or an antenna(s) of a network entity 105 or a receiver (such as the receiver 1010 or a receive processor) or an antenna(s) of a UE 115, or of other devices illustrated and described herein. Means for transmitting or means for outputting may include a transmitter (such as the transmitter 1015 or a transmit processor) or an antenna(s) of a network entity 110 or a transmitter (such as the transmitter 1015 or a transmit processor) or an antenna(s) of a UE 115, or of other devices illustrated and described herein. Means for detecting, means for forwarding, means for determining, and/or means for performing may include a processing system, which may include one or more processors, such as the communications manager 1020 or a processor 1340, a transmit MIMO processor, or a controller of a network entity 105 or a UE 115, or of other devices illustrated and described herein.

In some cases, rather than actually transmitting a frame or a packet, a device may have an interface to output a frame for transmission (a means for outputting). For example, a processor may output a frame, via a bus interface, to an RF front end for transmission. Similarly, rather than actually receiving a frame, a device may have an interface to obtain a frame received from another device (a means for obtaining). For example, a processor may obtain (or receive) a frame, via a bus interface, from an RF front end for reception.

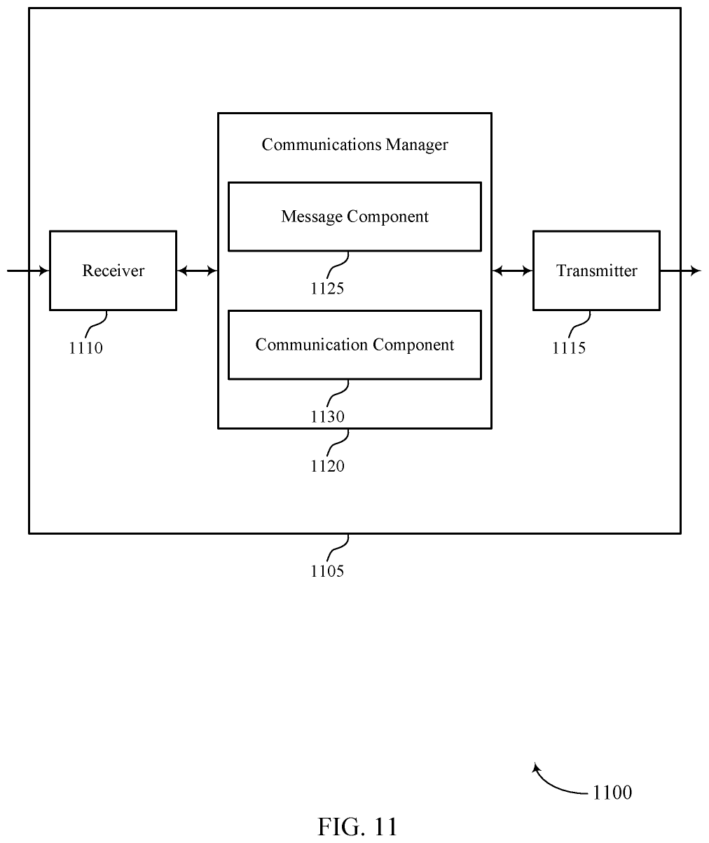

FIG. 11 shows a block diagram 1100 of a device 1105 that supports techniques for signaling in SBFD operation in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for signaling in SBFD operation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for signaling in SBFD operation). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for signaling in SBFD operation as described herein. For example, the communications manager 1120 may include a message component 1125 a communication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The message component 1125 may be configured as or otherwise support a means for obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The message component 1125 may be configured as or otherwise support a means for obtaining a second message indicating scheduling information for a signal, the scheduling information indicating a set of frequency resources of the slot, where the set of frequency resources includes a first frequency resource of the first subband and a second frequency resource of the second subband. The communication component 1130 may be configured as or otherwise support a means for communicating using the set of frequency resources according to the first reservation, the second reservation, or both.

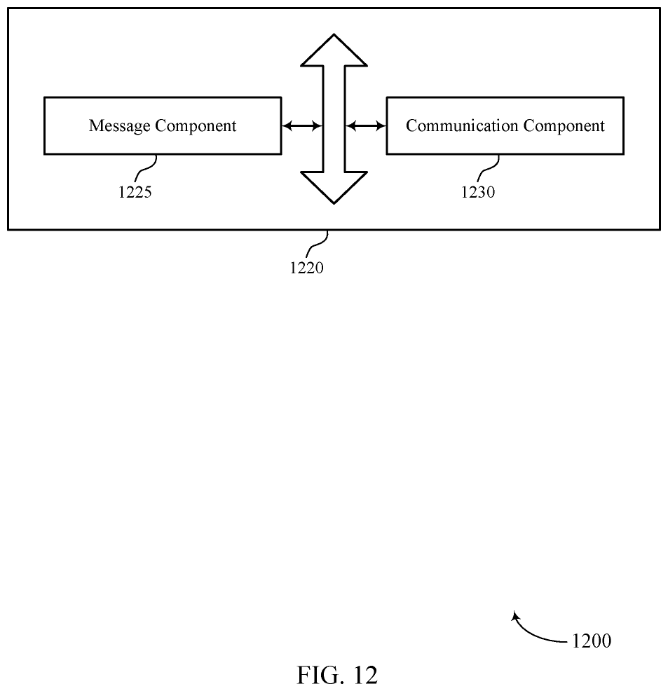

FIG. 12 shows a block diagram 1200 of a communications manager 1220 that supports techniques for signaling in SBFD operation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for signaling in SBFD operation as described herein. For example, the communications manager 1220 may include a message component 1225 a communication component 1230, or any combination thereof. Each of these components may communicate, directly or indirectly, with one another (e.g., via one or more buses).

Further, a component as described herein may be examples of means-plus-function components and may include one or more processors, processing systems, hardware and/or software components, controller, microcontroller, state machine, a DSP and a microprocessor, a plurality of microprocessors, one or more microprocessors in conjunction with a DSP core, programmable logic devices (PLDs), any other suitable circuitry, or any combination of circuits that may performed the various functionalities described throughout this disclosure.

The communications manager 1220 may support wireless communication in accordance with examples as disclosed herein. The message component 1225 may be configured as or otherwise support a means for obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. In some examples, the message component 1225 may be configured as or otherwise support a means for obtaining a second message indicating scheduling information for a signal, the scheduling information indicating a set of frequency resources of the slot, where the set of frequency resources includes a first frequency resource of the first subband and a second frequency resource of the second subband. The communication component 1230 may be configured as or otherwise support a means for communicating using the set of frequency resources according to the first reservation, the second reservation, or both.

In some examples, to support communication, the communication component 1230 may be configured as or otherwise support a means for monitoring the set of frequency resources for at least a first portion of the third message according to the first reservation, the second reservation, or both.

In some examples, to support communication, the communication component 1230 may be configured as or otherwise support a means for monitoring the second frequency resource of the second subband for the first portion of the third message according to the second reservation.

In some examples, to support communication, the communication component 1230 may be configured as or otherwise support a means for monitoring the third frequency resource for a second portion of the third message.

In some examples, to support communication, the communication component 1230 may be configured as or otherwise support a means for outputting, for transmission, at least a first portion of the third message using the set of frequency resources according to the first reservation, the second reservation, or both.

In some examples, to support communication, the communication component 1230 may be configured as or otherwise support a means for outputting, for transmission, the first portion of the third message using the first frequency resource of the first subband based on the first reservation.

In some examples, to support communications, the communication component 1230 may be configured as or otherwise support a means for outputting, for transmission, a second portion of the third message using a third one or more frequency resources of a guard band, the guard band including a third one or more subbands, where the set of frequency resources includes the guard band.

In some examples, the communication using the set of frequency resources is independent of communicating the signal.

In some examples, the message component 1225 may be configured as or otherwise support a means for outputting, for transmission, a feedback message independent of the communication, the feedback message including a negative acknowledgment associated with the signal.

In some examples, the communication using the set of frequency resources is further in accordance with priority information associated with the signal.

In some examples, the message component 1225 may be configured as or otherwise support a means for obtaining a third message indicating the priority information associated with the signal.

In some examples, the second direction is different than the first direction.

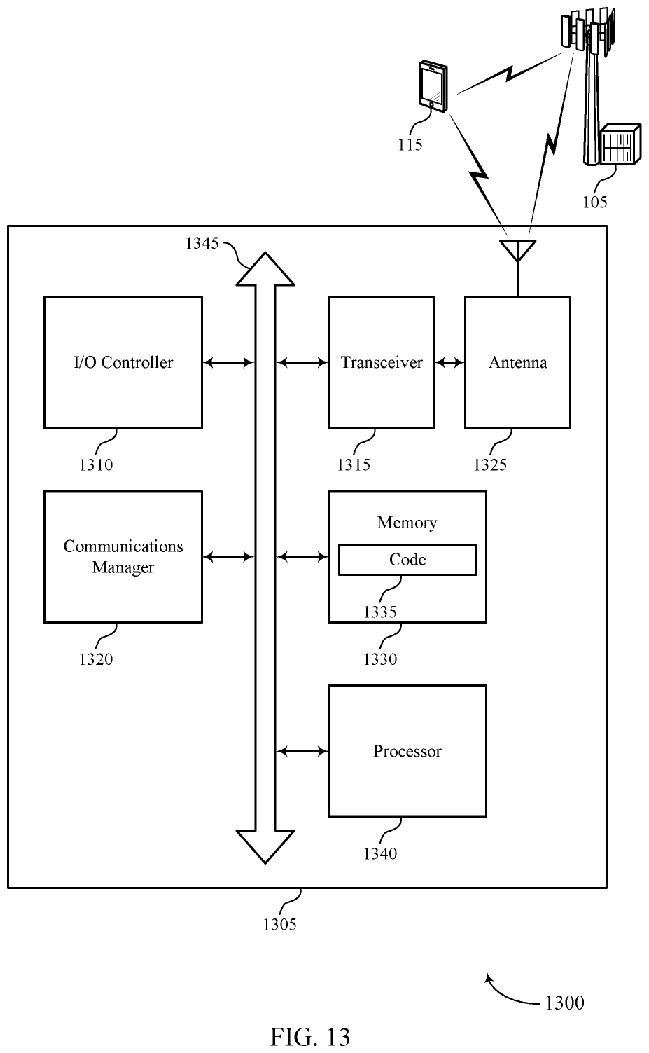

FIG. 13 shows a diagram of a system 1300 including a device 1305 that supports techniques for signaling in SBFD operation in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for signaling in SBFD operation). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communication in accordance with examples as disclosed herein. For example, the communications manager 1320 may be configured as or otherwise support a means for obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The communications manager 1320 may be configured as or otherwise support a means for obtaining a second message indicating scheduling information for a signal, the scheduling information indicating a set of frequency resources of the slot, where the set of frequency resources includes a first frequency resource of the first subband and a second frequency resource of the second subband. The communications manager 1320 may be configured as or otherwise support a means for communicating using the set of frequency resources according to the first reservation, the second reservation, or both.

By including or configuring the communications manager 1320 in accordance with examples as described herein, the device 1305 may support techniques for improved communication reliability, reduced latency, more efficient utilization of communication resources, or improved coordination between devices, among other benefits.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for signaling in SBFD operation as described herein, or the processor 1340 and the memory 1330 may be otherwise configured to perform or support such operations.

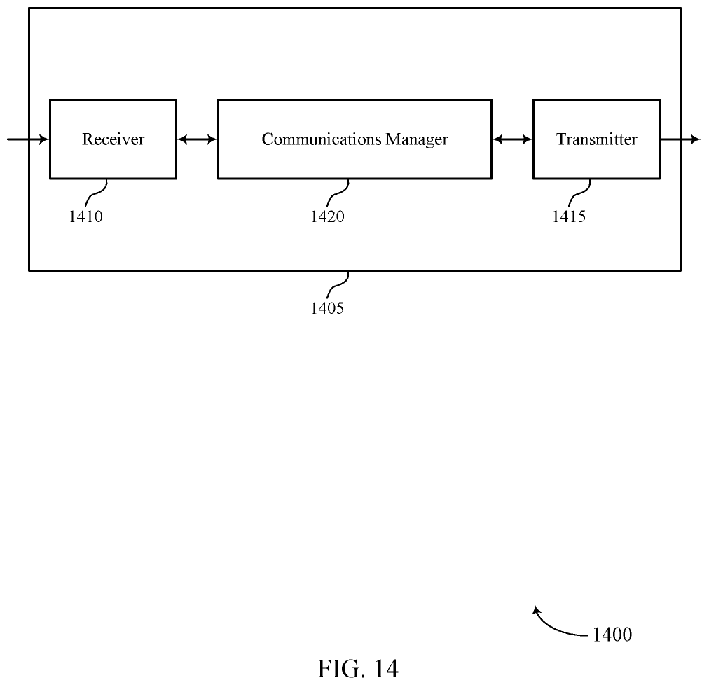

FIG. 14 shows a block diagram 1400 of a device 1405 that supports techniques for signaling in SBFD operation in accordance with one or more aspects of the present disclosure. The device 1405 may be an example of aspects of a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of techniques for signaling in SBFD operation as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. For example, the communications manager 1420 may be configured as or otherwise support a means for outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The communications manager 1420 may be configured as or otherwise support a means for outputting, for transmission, a second message indicating scheduling information for a signal, the scheduling information indicating a set of frequency resources of the slot, where the set of frequency resources includes a first frequency resource of the first subband and a second frequency resource of the second subband. The communications manager 1420 may be configured as or otherwise support a means for communicating using the set of frequency resources according to the first reservation, the second reservation, or both.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for reduced processing, reduced power consumption, or more efficient utilization of communication resources, among other benefits.

Means for receiving or means for obtaining may include a receiver (such as the receiver 1410 or a receive processor) or an antenna(s) of a network entity 105 or a receiver (such as the receiver 1410 or a receive processor) or an antenna(s) of a UE 115, or of other devices illustrated and described herein. Means for transmitting or means for outputting may include a transmitter (such as the transmitter 1415 or a transmit processor) or an antenna(s) of a network entity 105 or a transmitter (such as the transmitter 1415 or a transmit processor) or an antenna(s) of a UE 115, or of other devices illustrated and described herein. Means for detecting, means for forwarding, means for determining, and/or means for performing may include a processing system, which may include one or more processors, such as the communications manager 1420 or a processor 1735, a transmit MIMO processor, or a controller of a network entity 105 or a UE 115, or of other devices illustrated and described herein.

In some cases, rather than actually transmitting a frame or a packet, a device may have an interface to output a frame for transmission (a means for outputting). For example, a processor may output a frame, via a bus interface, to an RF front end for transmission. Similarly, rather than actually receiving a frame, a device may have an interface to obtain a frame received from another device (a means for obtaining). For example, a processor may obtain (or receive) a frame, via a bus interface, from an RF front end for reception.

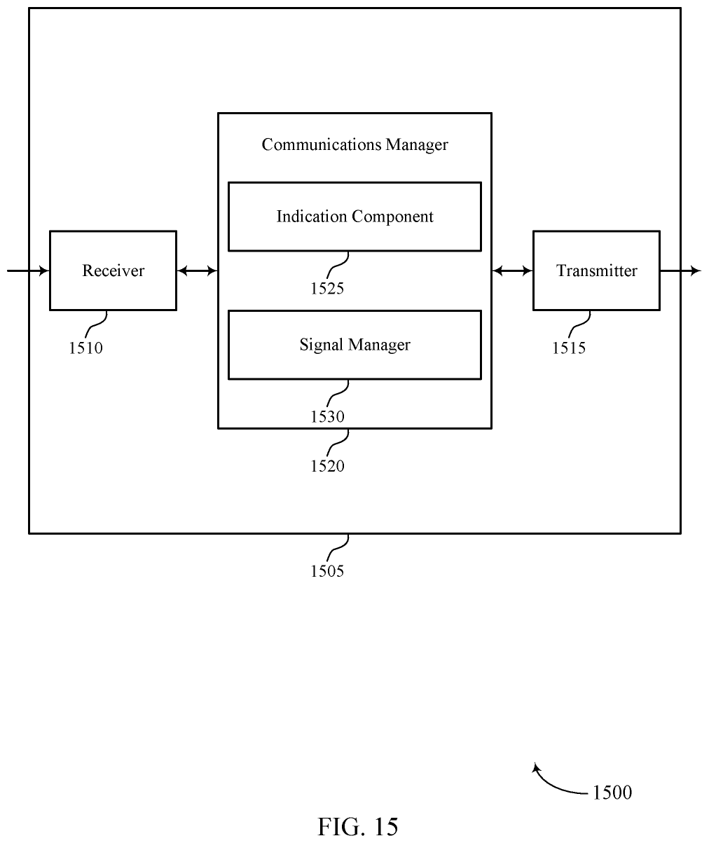

FIG. 15 shows a block diagram 1500 of a device 1505 that supports techniques for signaling in SBFD operation in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of techniques for signaling in SBFD operation as described herein. For example, the communications manager 1520 may include an indication component 1525 a signal manager 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication in accordance with examples as disclosed herein. The indication component 1525 may be configured as or otherwise support a means for outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The indication component 1525 may be configured as or otherwise support a means for outputting, for transmission, a second message indicating scheduling information for a signal, the scheduling information indicating a set of frequency resources of the slot, where the set of frequency resources includes a first frequency resource of the first subband and a second frequency resource of the second subband. The signal manager 1530 may be configured as or otherwise support a means for communicating using the set of frequency resources according to the first reservation, the second reservation, or both.

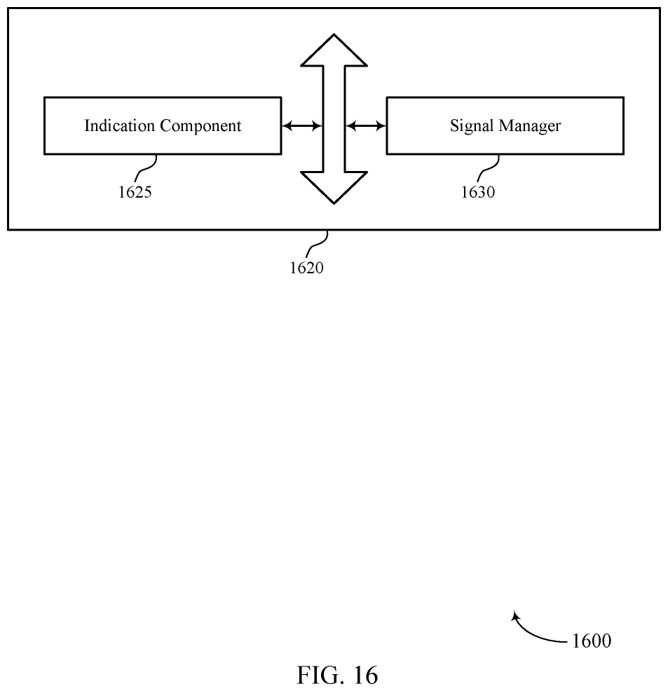

FIG. 16 shows a block diagram 1600 of a communications manager 1620 that supports techniques for signaling in SBFD operation in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of techniques for signaling in SBFD operation as described herein. For example, the communications manager 1620 may include an indication component 1625 a signal manager 1630, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Further, a component as described herein may be examples of means-plus-function components and may include one or more processors, processing systems, hardware and/or software components, controller, microcontroller, state machine, a DSP and a microprocessor, a plurality of microprocessors, one or more microprocessors in conjunction with a DSP core, PLDs, any other suitable circuitry, or any combination of circuits that may performed the various functionalities described throughout this disclosure.

The communications manager 1620 may support wireless communication in accordance with examples as disclosed herein. The indication component 1625 may be configured as or otherwise support a means for outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. In some examples, the indication component 1625 may be configured as or otherwise support a means for outputting, for transmission, a second message indicating scheduling information for a signal, the scheduling information indicating a set of frequency resources of the slot, where the set of frequency resources includes a first frequency resource of the first subband and a second frequency resource of the second subband. The signal manager 1630 may be configured as or otherwise support a means for communicating using the set of frequency resources according to the first reservation, the second reservation, or both.

In some examples, to support communication, the signal manager 1630 may be configured as or otherwise support a means for monitoring the set of frequency resources for at least a first portion of the third message according to the first reservation, the second reservation, or both.

In some examples, to support communication, the signal manager 1630 may be configured as or otherwise support a means for monitoring the first frequency resource of the first subband for the first portion of the third message according to the first reservation.

In some examples, to support communication, the signal manager 1630 may be configured as or otherwise support a means for monitoring the third frequency resource for a second portion of the third message.

In some examples, the signal manager 1630 may be configured as or otherwise support a means for outputting, for transmission, a fourth message using a third frequency resource of the second subband according to the second reservation.

In some examples, the signal manager 1630 may be configured as or otherwise support a means for monitoring a third frequency resource of the second subband for a fourth message.

In some examples, to support communication, the signal manager 1630 may be configured as or otherwise support a means for outputting, for transmission, at least a first portion of the third message using the set of frequency resources according to the first reservation, the second reservation, or both.

In some examples, to support communication, the signal manager 1630 may be configured as or otherwise support a means for outputting, for transmission, a first portion of the third message using the second frequency resource of the second subband according to the second reservation.

In some examples, to support communication, the signal manager 1630 may be configured as or otherwise support a means for outputting, for transmission, a second portion of the third message using the third frequency resource.

In some examples, the signal manager 1630 may be configured as or otherwise support a means for monitoring a third frequency resource of the first subband for a fourth message according to the first reservation, the fourth message associated with the first direction.

In some examples, the signal manager 1630 may be configured as or otherwise support a means for outputting, for transmission, a fourth message using a third frequency resource of the first subband, the fourth message associated with the second direction.

In some examples, the communication using the set of frequency resources is independent of communicating the signal.

In some examples, the signal manager 1630 may be configured as or otherwise support a means for obtaining a feedback message including a negative acknowledgment associated with the signal.

In some examples, the communication using the set of frequency resources is further in accordance with priority information associated with the signal.

In some examples, the signal manager 1630 may be configured as or otherwise support a means for outputting, for transmission, a third message indicating the priority information associated with the signal.

In some examples, the second direction is different than the first direction.

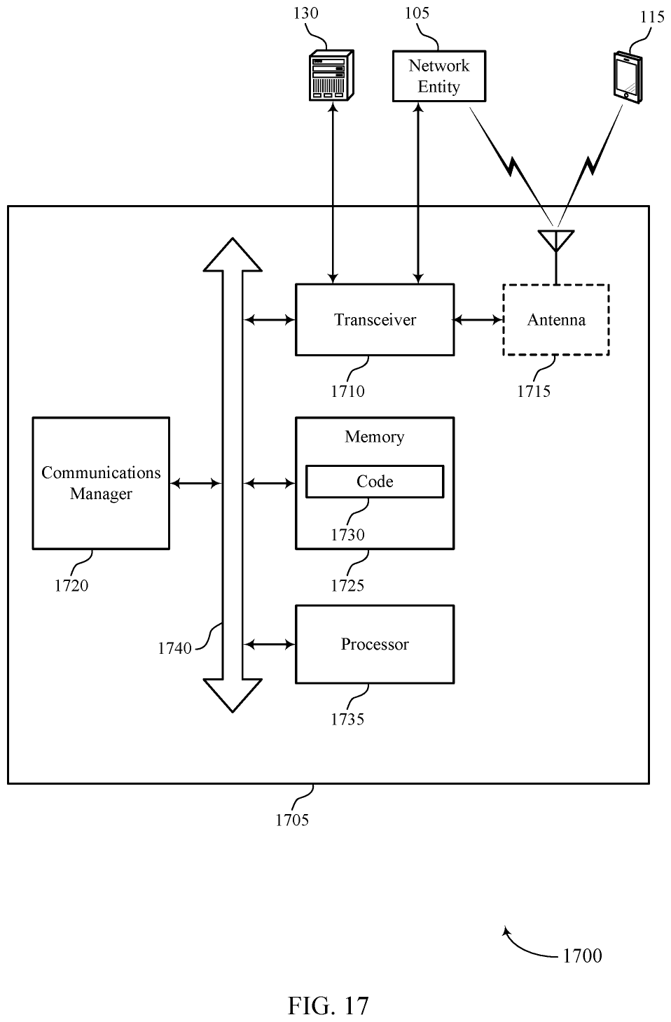

FIG. 17 shows a diagram of a system 1700 including a device 1705 that supports techniques for signaling in SBFD operation in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, a memory 1725, code 1730, and a processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or memory components (for example, the processor 1735, or the memory 1725, or both), may be included in a chip or chip assembly that is installed in the device 1705. In some examples, the transceiver may be operable to support communications via one or more communications links (e.g., a communication link 125, a backhaul communication link 120, a midhaul communication link 162, a fronthaul communication link 168).

The memory 1725 may include RAM and ROM. The memory 1725 may store computer-readable, computer-executable code 1730 including instructions that, when executed by the processor 1735, cause the device 1705 to perform various functions described herein. The code 1730 may be stored in a non-transitory computer-readable medium such as system memory or another type of memory. In some cases, the code 1730 may not be directly executable by the processor 1735 but may cause a computer (e.g., when compiled and executed) to perform functions described herein. In some cases, the memory 1725 may contain, among other things, a BIOS which may control basic hardware or software operation such as the interaction with peripheral components or devices.

The processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1735 may be configured to operate a memory array using a memory controller. In some other cases, a memory controller may be integrated into the processor 1735. The processor 1735 may be configured to execute computer-readable instructions stored in a memory (e.g., the memory 1725) to cause the device 1705 to perform various functions (e.g., functions or tasks supporting techniques for signaling in SBFD operation). For example, the device 1705 or a component of the device 1705 may include a processor 1735 and memory 1725 coupled with the processor 1735, the processor 1735 and memory 1725 configured to perform various functions described herein. The processor 1735 may be an example of a cloud-computing platform (e.g., one or more physical nodes and supporting software such as operating systems, virtual machines, or container instances) that may host the functions (e.g., by executing code 1730) to perform the functions of the device 1705. The processor 1735 may be any one or more suitable processors capable of executing scripts or instructions of one or more software programs stored in the device 1705 (such as within the memory 1725). In some implementations, the processor 1735 may be a component of a processing system. A processing system may generally refer to a system or series of machines or components that receives inputs and processes the inputs to produce a set of outputs (which may be passed to other systems or components of, for example, the device 1705). For example, a processing system of the device 1705 may refer to a system including the various other components or subcomponents of the device 1705, such as the processor 1735, or the transceiver 1710, or the communications manager 1720, or other components or combinations of components of the device 1705. The processing system of the device 1705 may interface with other components of the device 1705, and may process information received from other components (such as inputs or signals) or output information to other components. For example, a chip or modem of the device 1705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1705 may transmit information output from the chip or modem. Additionally, or alternatively, in some implementations, the one or more interfaces may refer to an interface between the processing system of the chip or modem and a receiver, such that the device 1705 may obtain information or signal inputs, and the information may be passed to the processing system. A person having ordinary skill in the art will readily recognize that a first interface also may obtain information or signal inputs, and a second interface also may output information or signal outputs.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the memory 1725, the code 1730, and the processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communication in accordance with examples as disclosed herein. For example, the communications manager 1720 may be configured as or otherwise support a means for outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The communications manager 1720 may be configured as or otherwise support a means for outputting, for transmission, a second message indicating scheduling information for a signal, the scheduling information indicating a set of frequency resources of the slot, where the set of frequency resources includes a first frequency resource of the first subband and a second frequency resource of the second subband. The communications manager 1720 may be configured as or otherwise support a means for communicating using the set of frequency resources according to the first reservation, the second reservation, or both.

By including or configuring the communications manager 1720 in accordance with examples as described herein, the device 1705 may support techniques for improved communication reliability, reduced latency, improved user experience related to reduced processing, more efficient utilization of communication resources, or improved coordination between devices, among other benefits.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, the processor 1735, the memory 1725, the code 1730, or any combination thereof. For example, the code 1730 may include instructions executable by the processor 1735 to cause the device 1705 to perform various aspects of techniques for signaling in SBFD operation as described herein, or the processor 1735 and the memory 1725 may be otherwise configured to perform or support such operations.

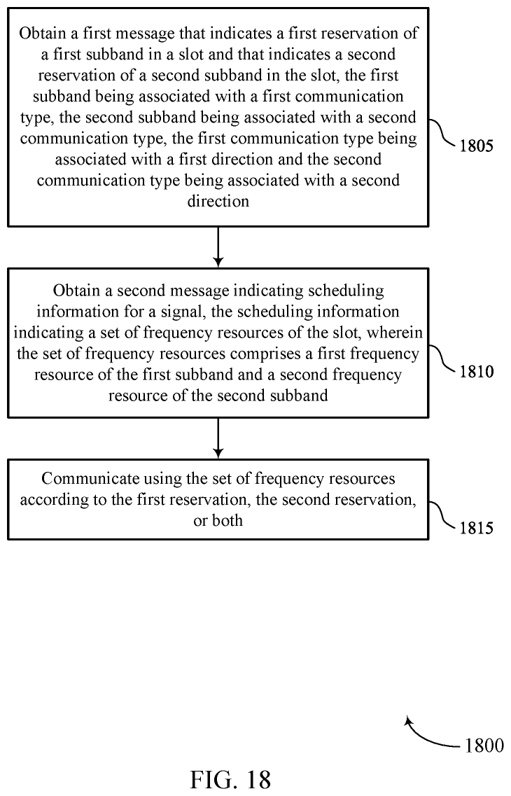

FIG. 18 shows a flowchart illustrating a method 1800 that supports techniques for signaling in SBFD operation in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The operations of 1805 may be performed in accordance with examples as disclosed herein. In some examples, aspects of the operations of 1805 may be performed by a message component 1225 as described with reference to FIG. 12.

At 1810, the method may include obtaining a second message indicating scheduling information for a signal, the scheduling information indicating a set of frequency resources of the slot, where the set of frequency resources includes a first frequency resource of the first subband and a second frequency resource of the second subband. The operations of 1810 may be performed in accordance with examples as disclosed herein. In some examples, aspects of the operations of 1810 may be performed by a message component 1225 as described with reference to FIG. 12.

At 1815, the method may include communicating using the set of frequency resources according to the first reservation, the second reservation, or both. The operations of 1815 may be performed in accordance with examples as disclosed herein. In some examples, aspects of the operations of 1815 may be performed by a communication component 1230 as described with reference to FIG. 12.

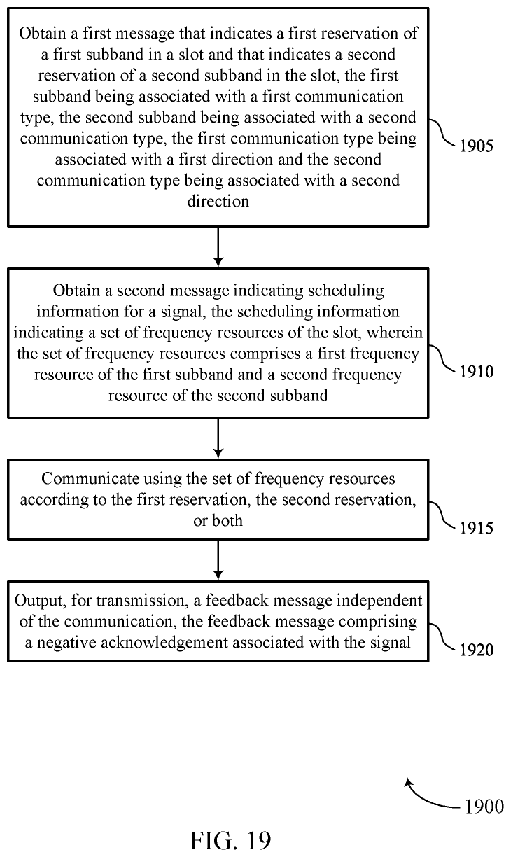

FIG. 19 shows a flowchart illustrating a method 1900 that supports techniques for signaling in SBFD operation in accordance with one or more aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The operations of 1905 may be performed in accordance with examples as disclosed herein. In some examples, aspects of the operations of 1905 may be performed by a message component 1225 as described with reference to FIG. 12.

At 1910, the method may include obtaining a second message indicating scheduling information for a signal, the scheduling information indicating a set of frequency resources of the slot, where the set of frequency resources includes a first frequency resource of the first subband and a second frequency resource of the second subband. The operations of 1910 may be performed in accordance with examples as disclosed herein. In some examples, aspects of the operations of 1910 may be performed by a message component 1225 as described with reference to FIG. 12.

At 1915, the method may include communicating using the set of frequency resources according to the first reservation, the second reservation, or both. The operations of 1915 may be performed in accordance with examples as disclosed herein. In some examples, aspects of the operations of 1915 may be performed by a communication component 1230 as described with reference to FIG. 12.

At 1920, the method may include outputting, for transmission, a feedback message independent of the communication, the feedback message including a negative acknowledgment associated with the signal. The operations of 1920 may be performed in accordance with examples as disclosed herein. In some examples, aspects of the operations of 1920 may be performed by a message component 1225 as described with reference to FIG. 12.

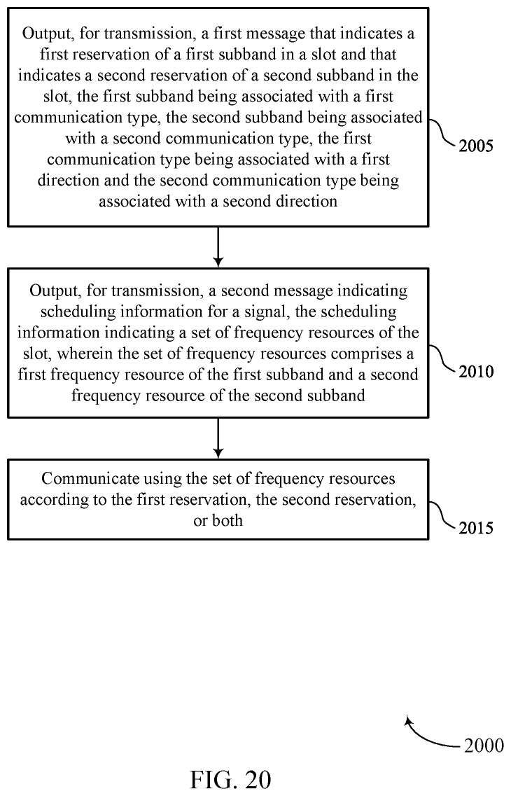

FIG. 20 shows a flowchart illustrating a method 2000 that supports techniques for signaling in SBFD operation in accordance with one or more aspects of the present disclosure. The operations of the method 2000 may be implemented by a network entity or its components as described herein. For example, the operations of the method 2000 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2005, the method may include outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The operations of 2005 may be performed in accordance with examples as disclosed herein. In some examples, aspects of the operations of 2005 may be performed by an indication component 1625 as described with reference to FIG. 16.

At 2010, the method may include outputting, for transmission, a second message indicating scheduling information for a signal, the scheduling information indicating a set of frequency resources of the slot, where the set of frequency resources includes a first frequency resource of the first subband and a second frequency resource of the second subband. The operations of 2010 may be performed in accordance with examples as disclosed herein. In some examples, aspects of the operations of 2010 may be performed by an indication component 1625 as described with reference to FIG. 16.

At 2015, the method may include communicating using the set of frequency resources according to the first reservation, the second reservation, or both. The operations of 2015 may be performed in accordance with examples as disclosed herein. In some examples, aspects of the operations of 2015 may be performed by a signal manager 1630 as described with reference to FIG. 16.

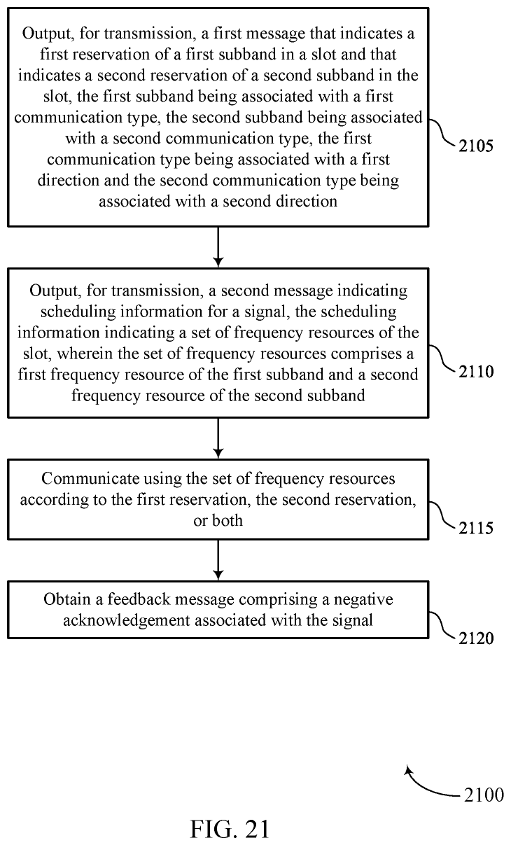

FIG. 21 shows a flowchart illustrating a method 2100 that supports techniques for signaling in SBFD operation in accordance with one or more aspects of the present disclosure. The operations of the method 2100 may be implemented by a network entity or its components as described herein. For example, the operations of the method 2100 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may include outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction. The operations of 2105 may be performed in accordance with examples as disclosed herein. In some examples, aspects of the operations of 2105 may be performed by an indication component 1625 as described with reference to FIG. 16.

At 2110, the method may include outputting, for transmission, a second message indicating scheduling information for a signal, the scheduling information indicating a set of frequency resources of the slot, where the set of frequency resources includes a first frequency resource of the first subband and a second frequency resource of the second subband. The operations of 2110 may be performed in accordance with examples as disclosed herein. In some examples, aspects of the operations of 2110 may be performed by an indication component 1625 as described with reference to FIG. 16.

At 2115, the method may include communicating using the set of frequency resources according to the first reservation, the second reservation, or both. The operations of 2115 may be performed in accordance with examples as disclosed herein. In some examples, aspects of the operations of 2115 may be performed by a signal manager 1630 as described with reference to FIG. 16.

At 2120, the method may include obtaining a feedback message including a negative acknowledgment associated with the signal. The operations of 2120 may be performed in accordance with examples as disclosed herein. In some examples, aspects of the operations of 2120 may be performed by a signal manager 1630 as described with reference to FIG. 16.

The following provides an overview of aspects of the present disclosure:

Aspect 1: A method for wireless communication at a UE, comprising: obtaining a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction; obtaining a second message indicating scheduling information for a signal, the scheduling information indicating a set of frequency resources of the slot, wherein the set of frequency resources comprises a first frequency resource of the first subband and a second frequency resource of the second subband; and communicating using the set of frequency resources according to the first reservation, the second reservation, or both.

Aspect 2: The method of aspect 1, wherein the signal comprises a third message associated with the second direction, and wherein the communication further comprises: monitoring the set of frequency resources for at least a first portion of the third message according to the first reservation, the second reservation, or both.

Aspect 3: The method of aspect 2, wherein the communication further comprises: monitoring the second frequency resource of the second subband for the first portion of the third message according to the second reservation.

Aspect 4: The method of any of aspects 2 through 3, wherein the set of frequency resources comprises a third frequency resource of a portion of a guard band, and wherein the communication further comprises: monitoring the third frequency resource for a second portion of the third message.

Aspect 5: The method of any of aspects 1 through 4, wherein the signal comprises a third message associated with the first direction, and wherein the communication further comprises: outputting, for transmission, at least a first portion of the third message using the set of frequency resources according to the first reservation, the second reservation, or both.

Aspect 6: The method of aspect 5, wherein the communication further comprises: outputting, for transmission, the first portion of the third message using the first frequency resource of the first subband based at least in part on the first reservation.

Aspect 7: The method of any of aspects 5 through 6, wherein the set of frequency resources comprises a third frequency resource of a portion of a guard band, and wherein the communications further comprises: outputting, for transmission, a second portion of the third message using a third one or more frequency resources of a guard band, the guard band comprising a third one or more subbands, wherein the set of frequency resources comprises the guard band.

Aspect 8: The method of any of aspects 1 through 7, wherein the communication using the set of frequency resources is independent of communicating the signal.

Aspect 9: The method of any of aspects 1 through 8, further comprising: outputting, for transmission, a feedback message independent of the communication, the feedback message comprising a negative acknowledgment associated with the signal.

Aspect 10: The method of any of aspects 1 through 9, wherein the communication using the set of frequency resources is further in accordance with priority information associated with the signal.

Aspect 11: The method of aspect 10, further comprising: obtaining a third message indicating the priority information associated with the signal.

Aspect 12: The method of any of aspects 1 through 11, wherein the second direction is different than the first direction.

Aspect 13: A method for wireless communication at a network entity, comprising: outputting, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction; outputting, for transmission, a second message indicating scheduling information for a signal, the scheduling information indicating a set of frequency resources of the slot, wherein the set of frequency resources comprises a first frequency resource of the first subband and a second frequency resource of the second subband; and communicating using the set of frequency resources according to the first reservation, the second reservation, or both.

Aspect 14: The method of aspect 13, wherein the signal comprises a third message associated with the first direction, and wherein the communication further comprises: monitoring the set of frequency resources for at least a first portion of the third message according to the first reservation, the second reservation, or both.

Aspect 15: The method of aspect 14, wherein the communication further comprises: monitoring the first frequency resource of the first subband for the first portion of the third message according to the first reservation.

Aspect 16: The method of any of aspects 14 through 15, wherein the set of frequency resources comprises a third frequency resource of a portion of a guard band, and wherein the communication further comprises: monitoring the third frequency resource for a second portion of the third message.

Aspect 17: The method of any of aspects 14 through 16, further comprising: outputting, for transmission, a fourth message using a third frequency resource of the second subband according to the second reservation.

Aspect 18: The method of any of aspects 14 through 17, further comprising: monitoring a third frequency resource of the second subband for a fourth message.

Aspect 19: The method of any of aspects 13 through 18, wherein the signal comprises a third message, and wherein the communication further comprises: outputting, for transmission, at least a first portion of the third message using the set of frequency resources according to the first reservation, the second reservation, or both.

Aspect 20: The method of aspect 19, wherein the communication further comprises: outputting, for transmission, a first portion of the third message using the second frequency resource of the second subband according to the second reservation.

Aspect 21: The method of any of aspects 19 through 20, wherein the set of frequency resources comprises a third frequency resource of a portion of a guard band, and wherein the communication further comprises: outputting, for transmission, a second portion of the third message using the third frequency resource.

Aspect 22: The method of any of aspects 19 through 21, further comprising: monitoring a third frequency resource of the first subband for a fourth message according to the first reservation, the fourth message associated with the first direction.

Aspect 23: The method of any of aspects 19 through 22, further comprising: outputting, for transmission, a fourth message using a third frequency resource of the first subband, the fourth message associated with the second direction.

Aspect 24: The method of any of aspects 13 through 23, wherein the communication using the set of frequency resources is independent of communicating the signal.

Aspect 25: The method of any of aspects 13 through 24, further comprising: obtaining a feedback message comprising a negative acknowledgment associated with the signal.

Aspect 26: The method of any of aspects 13 through 25, wherein the communication using the set of frequency resources is further in accordance with priority information associated with the signal.

Aspect 27: The method of aspect 26, further comprising: outputting, for transmission, a third message indicating the priority information associated with the signal.

Aspect 28: The method of any of aspects 13 through 27, wherein the second direction is different than the first direction.

Aspect 29: A UE, comprising: one or more transceivers and a processing system capable of performing a method of any of aspects 1 through 12, wherein the one or more transceivers are configured to: receive a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction; receive a second message indicating scheduling information for a signal, the scheduling information indicating a set of frequency resources of the slot, wherein the set of frequency resources comprises a first frequency resource of the first subband and a second frequency resource of the second subband; and communicate using the set of frequency resources according to the first reservation, the second reservation, or both.

Aspect 30: A network entity, comprising: one or more transceivers and a processing system capable of performing a method of any of aspects 13 through 28, wherein the one or more transceivers are configured to: transmit a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction; transmit a second message indicating scheduling information for a signal, the scheduling information indicating a set of frequency resources of the slot, wherein the set of frequency resources comprises a first frequency resource of the first subband and a second frequency resource of the second subband; and communicate using the set of frequency resources according to the first reservation, the second reservation, or both.

Aspect 31: An apparatus for wireless communication, comprising at least one processor; and memory comprising instructions executable by the at least one processor to cause the apparatus to perform a method of any of aspects 1 through 12.

Aspect 32: An apparatus for wireless communication, comprising at least one means for performing a method of any of aspects 1 through 12.

Aspect 33: A non-transitory computer-readable medium storing code for wireless communication, the code comprising instructions executable by a processor to perform a method of any of aspects 1 through 12.

Aspect 34: An apparatus for wireless communication, comprising at least one processor; and memory comprising instructions executable by the at least one processor to cause the apparatus to perform a method of any of aspects 13 through 28.

Aspect 35: An apparatus for wireless communication, comprising at least one means for performing a method of any of aspects 13 through 28.

Aspect 36: A non-transitory computer-readable medium storing code for wireless communication, the code comprising instructions executable by a processor to perform a method of any of aspects 13 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one processor; and
memory comprising instructions executable by the at least one processor to cause the apparatus to:
obtain a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction;
obtain a second message indicating scheduling information for a signal, the scheduling information indicating a set of frequency resources of the slot, wherein the set of frequency resources comprises a first frequency resource of the first subband and a second frequency resource of the second subband; and
communicate using the set of frequency resources according to the first reservation, the second reservation, or both.

2. The apparatus of claim 1, wherein the signal comprises a third message associated with the second direction, and wherein the instructions to communicate using the set of frequency resources are further executable by the at least one processor to cause the apparatus to:
monitor the set of frequency resources for at least a first portion of the third message according to the first reservation, the second reservation, or both.

3. The apparatus of claim 2, wherein the instructions to communicate using the set of frequency resources are further executable by the at least one processor to cause the apparatus to:
monitor the second frequency resource of the second subband for the first portion of the third message according to the second reservation.

4. The apparatus of claim 2, wherein the set of frequency resources comprises a third frequency resource of a portion of a guard band, and wherein the instructions to communicate using the set of frequency resources are further executable by the at least one processor to cause the apparatus to:
monitor the third frequency resource for a second portion of the third message.

5. The apparatus of claim 1, wherein the signal comprises a third message associated with the first direction, and wherein the instructions to communicate using the set of frequency resources are further executable by the at least one processor to cause the apparatus to:
output, for transmission, at least a first portion of the third message using the set of frequency resources according to the first reservation, the second reservation, or both.

6. The apparatus of claim 5, wherein the instructions to communicate using the set of frequency resources are further executable by the at least one processor to cause the apparatus to:
output, for transmission, the first portion of the third message using the first frequency resource of the first subband based at least in part on the first reservation.

7. The apparatus of claim 5, wherein the set of frequency resources comprises a third frequency resource of a portion of a guard band, and wherein the instructions to communicate using the set of frequency resources are further executable by the at least one processor to cause the apparatus to:
output, for transmission, a second portion of the third message using the third frequency resource.

8. The apparatus of claim 1, wherein the communication using the set of frequency resources is independent of communicating the signal.

9. The apparatus of claim 1, wherein the instructions are further executable by the at least one processor to cause the apparatus to:
output, for transmission, a feedback message independent of the communication, the feedback message comprising a negative acknowledgment associated with the signal.

10. The apparatus of claim 1, wherein the communication using the set of frequency resources is further in accordance with priority information associated with the signal.

11. The apparatus of claim 10, wherein the instructions are further executable by the at least one processor to cause the apparatus to:
obtain a third message indicating the priority information associated with the signal.

12. The apparatus of claim 1, wherein the second direction is different than the first direction.

13. An apparatus for wireless communication, comprising:
at least one processor; and
memory comprising instructions executable by the at least one processor to cause the apparatus to:
output, for transmission, a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction;
output, for transmission, a second message indicating scheduling information for a signal, the scheduling information indicating a set of frequency resources of the slot, wherein the set of frequency resources comprises a first frequency resource of the first subband and a second frequency resource of the second subband; and
communicate using the set of frequency resources according to the first reservation, the second reservation, or both.

14. The apparatus of claim 13, wherein the signal comprises a third message associated with the first direction, and wherein the instructions to communicate using the set of frequency resources are further executable by the at least one processor to cause the apparatus to:
monitor the set of frequency resources for at least a first portion of the third message according to the first reservation, the second reservation, or both.

15. The apparatus of claim 14, wherein the instructions to communicate using the set of frequency resources are further executable by the at least one processor to cause the apparatus to:
monitor the first frequency resource of the first subband for the first portion of the third message according to the first reservation.

16. The apparatus of claim 14, wherein the set of frequency resources comprises a third frequency resource of a portion of a guard band, and wherein the instructions to communicate using the set of frequency resources are further executable by the at least one processor to cause the apparatus to:
monitor the third frequency resource for a second portion of the third message.

17. The apparatus of claim 14, wherein the instructions are further executable by the at least one processor to cause the apparatus to:
output, for transmission, a fourth message using a third frequency resource of the second subband according to the second reservation.

18. The apparatus of claim 14, wherein the instructions are further executable by the at least one processor to cause the apparatus to:
monitor a third frequency resource of the second subband for a fourth message.

19. The apparatus of claim 13, wherein the signal comprises a third message, and wherein the instructions to communicate using the set of frequency resources are further executable by the at least one processor to cause the apparatus to:
output, for transmission, at least a first portion of the third message using the set of frequency resources according to the first reservation, the second reservation, or both.

20. The apparatus of claim 19, wherein the instructions to communicate using the set of frequency resources are further executable by the at least one processor to cause the apparatus to:
output, for transmission, a first portion of the third message using the second frequency resource of the second subband according to the second reservation.

21. The apparatus of claim 19, wherein the set of frequency resources comprises a third frequency resource of a portion of a guard band, and wherein the instructions to communicate using the set of frequency resources are further executable by the at least one processor to cause the apparatus to:
output, for transmission, a second portion of the third message using the third frequency resource.

22. The apparatus of claim 19, wherein the instructions are further executable by the at least one processor to cause the apparatus to:
monitor a third frequency resource of the first subband for a fourth message according to the first reservation, the fourth message associated with the first direction.

23. The apparatus of claim 19, wherein the instructions are further executable by the at least one processor to cause the apparatus to:
output, for transmission, a fourth message using a third frequency resource of the first subband, the fourth message associated with the second direction.

24. The apparatus of claim 13, wherein the communication using the set of frequency resources is independent of communicating the signal.

25. The apparatus of claim 13, wherein the instructions are further executable by the at least one processor to cause the apparatus to:
obtain a feedback message comprising a negative acknowledgment associated with the signal.

26. The apparatus of claim 13, wherein the communication using the set of frequency resources is further in accordance with priority information associated with the signal.

27. The apparatus of claim 26, wherein the instructions are further executable by the at least one processor to cause the apparatus to:
output, for transmission, a third message indicating the priority information associated with the signal.

28. The apparatus of claim 13, wherein the second direction is different than the first direction.

29. The apparatus of claim 13, further comprising:
one or more transceivers via which the first message and the second message are output for transmission, wherein the apparatus is configured as a network entity.

30. A user equipment (UE), comprising:
one or more transceivers configured to:
receive a first message that indicates a first reservation of a first subband in a slot and that indicates a second reservation of a second subband in the slot, the first subband being associated with a first communication type, the second subband being associated with a second communication type, the first communication type being associated with a first direction and the second communication type being associated with a second direction;
receive a second message indicating scheduling information for a signal, the scheduling information indicating a set of frequency resources of the slot, wherein the set of frequency resources comprises a first frequency resource of the first subband and a second frequency resource of the second subband; and
communicate using the set of frequency resources according to the first reservation, the second reservation, or both.
